(19) United States
(12) Patent Application Publication
(10) Pub. No.: US 2007/0190494 A1
(43) Pub. Date: Aug. 16, 2007

(54) MULTIPLAYER GAMING USING GPS-ENABLED PORTABLE GAMING DEVICES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/697,704

(22) Filed: Apr. 6, 2007

Related U.S. Application Data
(63) Continuation-in-part of application No. 11/344,612, filed on Jan. 31, 2006.
(63) Continuation-in-part of application No. 11/278,531, filed on Apr. 3, 2006.
(60) Provisional application No. 60/840,096, filed on Aug. 25, 2006.
(60) Provisional application No. 60/717,591, filed on Sep. 17, 2005.
(60) Provisional application No. 60/668,299, filed on Apr. 4, 2005.

(51) Int. Cl. G06F 19/00; A63F 9/24; A63F 13/00; G06F 17/00; F41A 33/00

(52) U.S. Cl. 434/11; 463/40; 463/42; 434/130; 434/305

(57) ABSTRACT

A method of providing a mobile gaming experience to a group of users of portable computing devices within a predefined spatial area. Positional data and orientational data from each of the portable computing devices is received and stored in a tracking database. Position and orientation sensors local for a first portable computing device are read to determine a current location and a current targeting vector for the first portable computing device. A targeting area within a real physical world is determined based on the current location and the current targeting vector. A determination is made regarding whether the first portable computing device scores a hit on a second portable computing device within the targeting area.

### RELATED APPLICATION DATA

This application claims priority to provisional application Ser. No. 60/840,096, filed Aug. 25, 2006, the disclosure of which is hereby incorporated by reference herein in its entirety; this application is a continuation-in-part of co-pending U.S. patent application Ser. No. 11/344,612, filed Jan. 31, 2006 and entitled “Pointing Interface for Person-to-Person Information Exchange,” which claims priority to provisional application Ser. No. 60/717,591, filed Sep. 17, 2005, the disclosures of which are hereby incorporated by reference in their entirety; and this application is also a continuation-in-part of co-pending U.S. patent application Ser. No. 11/278,531, filed Apr. 3, 2006 and entitled “Method and Apparatus for an On-Screen/Off-Screen First Person Gaming Experience,” which claims priority to provisional application Ser. No. 60/668,299, filed Apr. 4, 2005, the disclosures of which are hereby incorporated by reference in their entirety

### FIELD OF THE APPLICATION

The present invention relates to portable gaming devices.

### BACKGROUND

There are currently mobile social networking systems or applications known in the art. Such applications are generally operated as managed services by application service providers (“ASPs”) and operate using several common characteristics. For example, users typically create unique personal profiles that include basic information including age, gender, user name, interests, profession, history, testimonials and information about their network. In some applications, users map their relationship with other members, either by inviting other members to join their network (e.g., Friendster™ and/or Linkedin™), or by using software to scan existing relationships recorded in computer contact software (e.g., Spoke™ and/or Visible Path™). Most commonly, these applications provide such functions as friend-finding, text-dating and community message aggregation. Friend-finder applications (e.g., Dodgeball™) can identify the location of the user and the friend of a user and alert the user when the friend is within a certain proximity. Such applications may also consult the relationship map and identify “friends of friends” who have announced they are within a certain range of the user's vicinity. Text-dating applications (e.g., MobiVibe™) allow users to connect with new friends who meet age and gender criteria, enabling users to communicate, e.g., to exchange text messages. Community message aggregators (e.g., Upoc™) distribute messages from one member to all members within a specific community. A system disclosed in pending U.S. Patent Application Publication No. 2005/0177614, which is hereby incorporated by reference, enables like-minded mobile device users to meet one another, on a permission basis, based upon one or more factors, such as: each user's reciprocal networking objective, the nature of the industry in which the user works, the user's level within the management hierarchy of his or her company, any specialty function the individual may possess, and so forth.

A problem with the current mobile social networking systems is that they do not allow a user to target other users by simply pointing at the then current location of that target user (or target group of users). A pointing method is highly convenient and intuitive for users and provides a significant advantage over other more cumbersome and time-consuming methods, such as dialing a phone number, typing in an email-address, or entering a particular coordinate or identifier. Another problem with current mobile social networking applications is that they do not enable users to engage in collaborative multi-player games such as “tag” by pointing their portable computing devices, or a portion thereof, at the locations of other users and firing simulated weapons upon them.

### SUMMARY

The methods and apparatus as disclosed herein enable a portable gaming device users engage in a targeting game in which users wander about the real physical world and aim their portable gaming devices (or a portion thereof) at other users of other portable gaming devices as a means of scoring points, inflicting damage, or otherwise achieving gaming advantage with respect to the other users. Points scored, damaged inflicted, and/or other gaming advantage acquired as a result of a first user targeting a second user by aiming his or her portable gaming device at the location of the second user may be moderated in software by the intervening distance between the first and second user, the accuracy of the aiming vector performed by the first user as he or she aims his portable gaming device at the second user, intervening simulated barriers between the first user and the second user, the orientation of the second user with respect to portable computing device of the first user, the status of a simulated shields employed by the second user, and/or the selected simulated weapons mode and/or simulated ammunition level of the first user. In this way, a plurality of users may engage in a collaborative targeting game within the real world based upon their real relative locations, distance, and orientations within the real world as well as based upon simulated conditions such as weapons, barriers, shields, and ammunition levels.

A software application is executed by/running on a server or a group of servers. The application, which is operative to keep track of the current geographic location of a plurality of users, is utilized in connection with each user using a portable gaming device enabled with a Global Positioning System (“GPS”) transceiver. The portable gaming device, as defined herein, may be as dedicated personal gaming device such as a Gameboy™, or a general purpose portable computing device that is used to run a gaming application such as a cell phone, media player, Personal Digital Assistant (“PDA”), or another mobile computing device. The software application that runs on the server and keeps track of the current geographic location of each of a plurality of users is referred to herein as a user tracking application or “UTA.” The server or group of servers that runs the UTA software is referred to herein as the UTA server. Thus, embodiments of the present invention comprise a UTA server that is in wireless communication with a plurality of portable gaming devices, with the UTA server receiving and storing current geographic location information from each of the plurality of portable gaming devices, thereby keeping track of the current geographic location of each user of the each of the plurality of portable gaming devices.

A gaming application moderates game play among the plurality of users. The gaming application may run upon the UTA server or upon a separate processor or server that is in signal communication with the UTA server. For simplicity of the current description, the gaming application will be described as running upon the UTA server although it may run on other processors, including at least in part upon the processor of one or more portable gaming devices. In some embodiments a first user may also initiate communication with a second user through the portable gaming devices, thereby enabling a user to hold a verbal conversation with teammates and/or opponents.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a UTA server, which is connected or connectable to one or more networks for implementing a managed service according to an embodiment of the invention;

FIG. 2 illustrates a portable gaming device configured with appropriate hardware and software according to an embodiment of the invention;

FIGS. 3, 3b, and 4 illustrate a method of operation according to an embodiment of the invention;

FIGS. 5a-5d illustrate current positional coordinates of the portable gaming device according to an embodiment of the invention;

FIG. 6 illustrates a collaborative gaming process wherein two users work together to score a hit upon a third user by each targeting the third user at the same time according to an embodiment of the invention;

FIG. 7 illustrates a portable gaming device aimed by a targeting user in a particular direction according to an embodiment of the invention; and

FIG. 8 illustrates a multi-step targeting method in which the user specifies two targeting vectors that bound an angular targeting region according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention enable a multi-player real-world gaming experience using handheld portable gaming devices enabled with GPS transceivers and orientation sensors. Embodiments of the present invention are comprised of methods and apparatus that enable a first user of a first GPS enabled portable gaming device to target a second user of a second GPS enabled portable gaming device by pointing a portion of the first portable gaming device at the current spatial location of the second user while simultaneously engaging an appropriate element of a user-interface of the first portable gaming device. More specifically, embodiments of the present invention allow a first user of a first portable gaming device to target a second user of a second portable gaming device and fire a simulated weapon upon the second user by the first user by pointing a portion of his portable gaming device in a direction that is substantially aimed at the current location of the second user and engaging an appropriate element of a user-interface of the first portable gaming device. In addition, embodiments of the present invention provide unique methods in which the first and/or second portable computing devices establish and monitor simulated shields, establish and monitor simulated barriers, establish and monitor simulated weapons and ammunition, establish and monitor simulated heath levels, and/or maintain gaming scores related to the targeting and firing of the simulated weapons and the like.

Embodiments of the present invention relate to the field of video games. Whether implemented on a personal computer, television-based gaming console, or handheld gaming system, traditional video games allow users to manipulate on-screen characters and thereby engage in on-screen challenges or competitions. While such on-screen challenges or competitions are fun and engaging for users, they often pull players away from the real physical world and cause them to sit mesmerized in a single location for hours at a time, fixated upon a glowing screen. This is true even for games played upon Portable Gaming Systems. Such devices are small and handheld and can allow users to walk around, but the gaming action is still restricted entirely to the screen. As a result players using Portable Gaming Systems just sit in one spot (or stand in one spot) and passively stare down at their screen. What is therefore needed is a novel means of combining the benefits of computer generated gaming content with real-world off-screen activities such that a user who is playing a game is actively moving about a real physical space as part of the gaming experience. Furthermore what is needed are technologies that allow a plurality of users to complete in a combined gaming experience that includes off-screen action moderated through the use of simulated gaming constructs.

Embodiments of the present invention also relate generally to person-to-person communication such as that enabled by portable devices such as cellular phones, personal digital assistants, and other similar mobile electronic devices with communication capabilities. Embodiments of the present invention also relate to mobile social networking applications that track the location of a plurality of users of mobile electronic devices upon one or more servers that are accessible by one or more of the plurality of users over a communication link.

The methods and apparatus as disclosed herein enable the portable gaming device users to engage in a targeting game in which users wander about the real physical world and aim their portable gaming devices (or a portion thereof) at other users of other portable gaming devices as a means of scoring points, inflicting damage, or otherwise achieving gaming advantage with respect to the other users. Points scored, damaged inflicted, and/or other gaming advantage acquired as a result of a first user targeting a second user by aiming his or her portable gaming device at the location of the second user may be moderated in software by the intervening distance between the first and second user, the accuracy of the aiming vector performed by the first user as he or she aims his portable gaming device at the second user, intervening simulated barriers between the first user and the second user, the orientation of the second user with respect to portable computing device of the first user, the status of a simulated shields employed by the second user, and/or the selected simulated weapons mode and/or simulated ammunition level of the first user. In this way, a plurality of users may engage in a collaborative targeting game within the real world based upon their real relative locations, distance, and orientations within the real world as well as based upon simulated conditions such as weapons, barriers, shields, and ammunition levels. In some embodiments, the targeting game is enabled upon GPS enabled handheld cell phone devices of a plurality of users such that when a first user aims his or her cell phone in the direction of the second user within the real physical world and engages a particular user interface command, the first user is operative to score simulated points, inflict simulated damage, or otherwise gain a simulated gaming advantage as a result of the successful targeting.

A software application is executed by/running on a server or a group of servers. The application is operative to keep track of the current geographic location of a plurality of users, with each user using a portable gaming device enabled with a GPS transceiver. The portable gaming device, as defined herein, may be as dedicated personal gaming device such as a Gameboy™, or a general purpose portable computing device that is used to run a gaming application such as a cell phone, media player, PDA, or other mobile computing device. The software application that runs on the server and keeps track of the current geographic location of each of a plurality of users is referred to herein as a user tracking application or UTA. The server or group of servers that runs the UTA software is referred to herein as the UTA server. Thus, embodiments of the present invention comprise a UTA server that is in wireless communication with a plurality of portable gaming devices, with the UTA server receiving and storing current geographic location information from each of the plurality of portable gaming devices, thereby keeping track of the current geographic location of each user of the each of the plurality of portable gaming devices. In some embodiments, the current geographic location is a spatial coordinate, such as a longitude and latitude coordinate, for the user and/or for the portable gaming device. In some embodiments the current geographic location also includes an orientation vector for the user and/or for a portion of the portable gaming device. In some embodiments the current geographic location also includes a time-stamp reflecting the time at which the location and/or orientation data was detected by sensors local to the portable gaming device.

By “current geographic location” it is understood that there will generally be some amount time lag that causes the most current location stored for some or all users upon the UTA server to reflect that user's location at a recent time in the past. It is therefore desirable for the current invention to keep such time lags as small as possible within the practical limitations of the technology employed. It is also desirable for some embodiments of the current invention to store a time-history of current geographic locations for the plurality of users, the time-history reflecting one or more previous but recent locations of each of the plurality of users. Furthermore, in some embodiments of the present invention the UTA application running on the UTA server may be operative to predict a current location of a user based at least in part upon the stored time-history of previous locations of that user. Furthermore, in some embodiments of the present invention the UTA application running on the UTA Server may be operative to predict a current location of a user based in part upon a velocity derived from the stored time-history of previous locations of that user. Furthermore, in some embodiments of the present invention the UTA application running on the UTA server may be operative to predict a current location of a user based in part upon velocity and/or acceleration and/or direction of motion data received for that user over a communication link.

In addition to tracking the current location of a plurality of users, each using a portable gaming device, the UTA application as disclosed herein may also be operative to store a unique personal profiles for each of the plurality of users, the unique personal profile including personal information such as a name, handle, gaming character information, gaming preference information, historical score information for games played, historical skill level information games played, and/or timing data reflecting amount of gaming usage performed by the user in the past. The personal profile information may also include personal demographic information for the user such as the user's age, gender, name, interests, profession, political affiliations, organizational affiliations, school affiliations, team affiliations, job title, marital status, sexual orientation, height, weight, highest level of education, IQ, music preferences, sports team preferences, dietary preferences, hobbies, income, and/or fitness level for each user. The personal profile information may also include gaming teaming information that indicates a particular team gaming team that the user is associated with. The UTA application may also be operative to store information about each user's friends and/or business associates in their social network, maintaining a map or other storage of their personal relationships with other users. Such information, whether it be personal or business related, is referred to herein as social networking information. The UTA application may also be operative to store access-preference information for each user, the access-preference information describing and/or limiting how other users may gain information about and/or initiate communication with that user. For example, access-preference information may limit access to some or all personal information for a particular user only to other users who are members of certain gaming teams or sub-teams, who have reached a certain gaming skill level, who have achieved a certain gaming score thresholds, who have accrued a certain amongst of gaming usage, who match certain demographic criteria, possess certain characteristics, and/or meet certain security requirements. Similarly, access-preference information may limit communication with a particular user only to other users who match certain demographic criteria, possess certain characteristics, and/or meet certain security requirements. In some embodiments the certain security requirements includes a particular user possessing a password or satisfying some other authentication. In some embodiments the certain criteria includes a particular user being a member of a particular network of friends or business associates. In some embodiments the certain characteristics includes a particular user having a certain combination of demographic characteristics such as age, gender, and/or grade level. The personal information stored for each user on the UTA server may be indexed by a user's name, social security number, biometric sample, or other commonly known personal identifier. Such personal information may alternatively be indexed by a server specific identifier that does not include a user's name, social security number, or other widely known personal identifier. In this way a user may maintain a personal profile the UTA server with substantial personal information but still remain substantially anonymous.

The UTA server is accessed by a plurality of users, with each of the users using a portable gaming device with wireless network capability and spatial location tracking using a GPS transducers and/or other position and/or orientation determining components. In a common embodiment the orientation determining components include a magnetometer integrated into an aimable portion of the portable gaming device. In some embodiments a second magnetometer is worn by the user, for example upon his belt or within his shoe, to determine a user facing direction. In this way a plurality of magnetometers may be used, one to track the aiming direction of an aimable portion of the portable gaming device and one to track the facing direction of the user. The second magnetometer used to track the facing direction of the user is generally connected by Bluetooth link to the portable gaming device. In this way it may be remotely worn upon the body of the user in a predictable manner regardless of how the portable gaming device is aimed by the user during game play.

A gaming application moderates game play among the plurality of users. The gaming application may run upon the UTA server or upon a separate processor or server that is in signal communication with the UTA server. For simplicity of the teachings discussed herein, the gaming application is described as running upon the UTA server although it may run on other processors, including at least in part upon the processor of one or more portable gaming devices.

In this way, the methods and apparatus as disclosed herein enable the portable gaming device users to engage in a targeting game in which users aim their portable gaming devices (or a portion thereof) at others users of other portable gaming devices as a means of scoring simulated points, inflicting simulated damage, or otherwise achieving a simulated gaming advantage with respect to the other users. The act of scoring simulated points, inflicting simulated damage, and/or otherwise achieving a simulated gaming advantage as a result of a first user successfully targeting a second user is referred to herein as “scoring-a-hit.” Thus, embodiments of the present invention provide methods and apparatus that enable a multi-user game to be played in which a first user may score-a-hit upon a second user by successfully aiming his portable computing device, or a portion thereof, upon the location of the second user. The amount of points, amount of damage, or degree of other gaming advantage awarded to the first user as a result of scoring-a-hit upon the second user may dependent upon real and simulated conditions, including the real physical distance between the users, the relative orientation of the second user with respect to the aiming vector of the first user, the status of any simulated shields used by the second user, the status of any intervening simulated barriers present between the first user and the second user, and/or the status of any simulated weapons modes and ammunition levels of the first user.

The determination of whether a first user scores-a-hit upon a second user depends upon the first user targeting the second user by pointing at least a portion of his or her portable gaming device at the current physical location of the second user. The determination of whether the first user scores-a-hit upon the second user and/or the extent of the resulting gaming advantage that the first user may achieve, may also be dependent upon (i) simulated shield levels associated with the second user, (ii) simulated barrier within the intervening distance between the first and second user, (iii) the real physical distance between the first and second user, (iv) the facing orientation of the second user with respect to the targeting vector from the first user, (v) and the simulated weapons selection and/or ammunition types or levels associated with the targeting of the second user by the first user, (vi) a team association of the first and/or second users, (vii) a character type or kind associated with the first and/or second users, (viii) personal profile parameters and/or identification parameters established by the first user and optionally stored as personal profile information for that user upon the UTA server, and/or (ix) social networking data associated with the first user and/or second user and optionally stored as social networking information for those users upon the UTA server. The determination of whether the first user scores-a-hit upon the second user and/or the extent of the resulting gaming advantage achieved by the first user, may also be dependent upon one or more specific demographic traits associated with the first user and/or the second user, the personal demographic traits associated with the second user including but not limited to data reflecting the age, gender, occupation, sexual orientation, height, weight, income, IQ, highest level of education, political party, personal interests, group memberships, school affiliations, company affiliations, team affiliations, job title, level of corporate hierarchy, and/or marital status of that user, and/or any combination of the aforementioned.

Embodiments of the present invention may be implemented as a computer system that facilitates multi user gaming activities by and among portable gaming device users. In one embodiment, portable gaming device users use a Web browser (on a computer, or the portable device itself) to register online for a managed networking service that is provided by a system operator who administers the system and manages information accesses and/or game play and/or communications between registered portable gaming device users. In particular, the system operator runs at least one UTA server that tracks the locations of a plurality of active portable gaming device users and programmatically identifies based upon received data and computation, when one of the portable gaming device users targets another of the portable gaming device users. The server also maintains data about the users to regulate gaming status and/or communication initiation, the data optionally including personal profile information, access-preference information, gaming scores, gaming parameters, the locations of simulated barriers, the status of simulated shields, the status of simulated ammunition levels, and/or social networking information. The information may be supplied by (or derived from) the respective portable gaming device users during the registration process and/or during subsequent gaming interactions with the UTA server. The information may include, but is not limited to, personal identification information, personal gaming preferences, gaming team affiliations, gaming status and configuration data, personal password information, and/or personal demographic data.

The UTA server interfaces to a telecommunications network through a gateway, such as a message gateway. As discussed above, whether a first registered portable gaming device user scores a hit upon a second registered portable gaming device user typically depends on several factors. One of the factors is the first user successfully targeting the second user by pointing at his or her current physical location. Other of the factors are based upon real physical conditions such as the distance between the users and simulated conditions such as the state and status of simulated weapons, ammunition, shields, and intervening barriers. Other of the factors may also include the relative orientation of the second user with respect to the aiming vector of the first user. For example, in some embodiments a first user may only score-a-hit upon a second user if hitting that user from behind (i.e., from substantially rear of the user's facing direction). Upon a hit being scored upon a second user, the second user may be provided with a visual, audio, and/or tactile alert indicating that he or she has been hit. For example, a sound effect may be played by the portable gaming device. In addition, information may be displayed to the second user as to the identity (real or simulated) of the first user who scored the hit. In addition, a message associated with the first user may be displayed to the second user upon a successful hit—for example, “Got you!” This message may be preplanned or composed in real time by the first user. The message may be textual, audio, and/or video in nature. The message may provide the first user's name, ID, handle, or other identifier. The message may also provide the second user with demographic information and/or team information and/or score information and/or social networking information about the first user. The message may also provide the second user with spatial information about the location of the first user relative to the second user. For example, a graphical map may be displayed that indicates the relative location of the first user with respect to the second user, depicting the relative distance and direction in which the first user currently resides. In this way the second user may more easily look around and spot the first user, who may be standing behind him for example.

Whether a first registered portable gaming device user is enabled to target a second registered portable gaming device user typically also depends upon whether the second registered portable device user has configured his or her status parameters to an “active” setting. When “active,” a user has informed the UTA server to track his or her location and moderate game play with respect to other users. When “inactive,” a user has informed the UTA server not to track his or her location and/or not to moderate game play. To encourage users to remain active, many embodiments of the present invention award points, health credits, ammunition credits, and/or other gaming advantage units in response to the accrued time that a user is “active” and/or reduces points, health credits, ammunition credits and/or other gaming advantage units in response to accrued time that a user is “inactive.” In this way a user must remain active for substantial amounts of time in order to gain gaming advantage with respect to other users. In some embodiments the user gains more gaming advantage units as a result of the distance traversed while active, thus encouraging users to not only be active but be mobile. In some embodiments users are provided with a limited amount of time for which they can be inactive, earning such time through gaming actions such as being active. Thus, a user is forced to remain active for a certain percentage of his or her time. In some such embodiments a user loses the game, is disqualified, or otherwise receives a gaming punishment as a result of being inactive for more than some allowed amount of time.

As discussed above, embodiments of the current invention enable a first user of a first portable gaming device to score-a-hit upon a second user of a second portable gaming device, subject to certain factors, by physically pointing the first portable gaming device (or a portion thereof) at the currently viewed location of the second user. To enable this inventive functionality, the present invention employs a plurality of portable gaming devices, each equipped with a positioning system such as a GPS transducer interfaced with a Navistar GPS and each having wireless access to UTA server running UTA software. In addition each portable gaming device includes at least one orientation sensing system which may or may not employ GPS transducers. In one common embodiment each portable gaming device includes a magnetometer for orientation sensing, the magnetometer used alone and/or in combination with other sensors such as GPS sensors and/or accelerometer sensors for detecting the current orientation of the portable gaming device with which it is associated. In some embodiments a second magnetometer is worn on the person of a user, for example on or within his belt or shoe in a known orientation, thus tracking the facing direction of the user. In this way a first magnetometer may track the targeting direction of the user's portable gaming device as held by the user and a second magnetometer may track the facing direction of the user based upon how he or she is standing or sitting.

Communication between each portable gaming device and the UTA server is generally enabled through a wireless transceiver connected to and/or integrated within each of the plurality of portable gaming devices. The GPS transducer and/or other position and/or orientation transducers associated with each portable gaming device are operative to generate a coordinate entry that relates to the then current position (and orientation) of that portable gaming device, the coordinate entry and/or a representation thereof is communicated over the wireless communication link to the UTA server running the UTA software along with identifying information that indicates from which portable gaming device (and/or which user) the coordinate entry was received. In this way the UTA server running the UTA software receives coordinate information representing the then current location (and orientation) of each of a plurality of user's using their own portable gaming device. In common embodiments each portable gaming device has a unique ID associated with it such that when coordinate data is transmitted to the UTA server it is sent along with the unique ID such that the UTA server can track by means of the unique ID which portable gaming device among the plurality of portable gaming devices having access to the UTA server the coordinate data is associated with. In some embodiments each user of a portable gaming device has a unique ID associated with that user such that when coordinate data is transmitted to the UTA server it is sent along with the unique ID such that the UTA server can track by means of the unique ID which user among the plurality of users who are members of the UTA server system the coordinate data is associated with. In some embodiments of the present invention the coordinate data generally includes only positional information, except when a user is performing a targeting operation, in which case the coordinate data also includes orientation information. This is done to reduce communication load. In other embodiments both position and orientation are always sent.

An important aspect of the present system is the inventive user targeting method by which a first user of a first portable gaming device can score-a-hit upon a second user of a second portable gaming device by physically pointing the first portable gaming device (or a portion thereof) at the currently viewed location of the second user which is some distance away from the first user. Another important aspect of the present system is the inventive group targeting method by which a first user of a first portable gaming device can selectively target and score-a-hit upon a group of other user of other portable gaming devices by physically pointing the first portable gaming device (or a portion thereof) at the currently viewed location of the group of other users. It is valuable to note that the targeting method employ geospatial data (for example GPS) and thus a hit may be scored upon a second user regardless of real physical intervening obstacles such as other people, walls, foliage, and structures. It is also valuable to note that simulated barriers may be included within the geospatial database, the simulated barriers being overlaid upon the real physical terrain based upon geospatial mappings. The simulated barriers may impermeable to simulated weapons fire and/or may be semi-permeable to simulated weapons fire, thereby preventing a first user from scoring a hit upon a second user.

Semi-permeable simulated barriers may prevent a first user from scoring a hit upon a second user if the targeting vector passes through the barrier and if the distance between the users is more than some threshold. Semi-permeable simulated barriers may prevent a first user from scoring a hit upon a second user if the targeting vector passes through the barrier and if the simulated weapon type and/or simulated ammunition type is not of a particular type or category. Semi-permeable simulated barriers may prevent a first user from scoring a hit upon a second user if the targeting vector passes through the barrier and if the first user does not have a team affiliation, demographic type, status level, score level, health level, or other personally associated attribute that matches or exceeds some required value or type. For example, certain semi-permeable simulated barriers may be configured only to allow members of a certain team to score-hits through the barrier. Similarly, certain semi-permeable simulated barriers may be configured to allow only a user with a particular ID, a particular password, or a particular authentication value or status to score hits through the barrier. Semi-permeable simulated barriers may prevent a first user from scoring a hit upon a second user if the targeting vector passes through the barrier in a certain direction or range of directions. For example, a semi-permeable simulated barrier may be constructed as a one-way barrier, allowing hits to be scored if the targeting route from first user to second user crosses the barrier in one sense (i.e., from a first side of the barrier to the second side), but not allow hits to be scored if the targeting route from the first user to the second user crosses the battier in the opposite sense (i.e., from the second side of the barrier to the first side). In some embodiments only targeting vectors that cross the simulated barrier at certain incident angles may score a hit through the semi-permeable barrier. In this way, targeting angles are reduced through the barrier. In some embodiments a hit may be scored through a semi-permeable barrier but the intensity of the resulting effect (i.e. the score, damage, or other gaming advantage attained by the first user) is reduced as a result of the targeting vector from first user to second user having crossed the simulated barrier.

In common embodiments the targeting methods are configured such that they employ a targeting vector, targeting coordinate, and/or a plurality of targeting coordinates that represent the location and/or locations at which the first user is aiming when performing a targeting function. The targeting vector, targeting coordinate, and/or plurality of targeting coordinates are then transmitted as data to the UTA server, either directly or as a coded representation. The UTA server then uses the targeting vector, targeting coordinate, and/or plurality of targeting coordinates along with the then current location of the first user to determine based upon the stored locational tracking information for a plurality of other users which of the other user or users the first user is most likely targeting. Such user(s) are referred to herein as targeted users. Once it is determined which user or users the first user is most likely targeting, i.e., the targeted users, the UTA server retrieves personal profile information for the targeted user(s) along with gaming preference information and/or gaming status information and/or simulated barrier and/or simulated shield information and/or simulated weapon information. The UTA server then determines based upon the information if the first user scores-a-hit upon the second user and/or the result of the hit. If a hit is score, and/or if the magnitude of the hit is above a certain amount and/or if the first user has made a request to do so, a message may be communicated from the first user to the second user through the intervening server. The message is then displayed to the second user as textual, video, graphical, audio, and/or tactile information. In addition, or alternately, information about the second user may be provided and displayed to the first user. This information may be accessed from profile information stored in the UTA server or may be conveyed directly from the second portable gaming device to the first portable gaming device. In some embodiments, the information conveyed to the first user may be ID information, team information, and/or secret gaming information that is accessed by the first user as a result of the first user successfully scoring a hit upon the second user. In some such embodiments the second user may be in possession of simulated points, simulated ammunition, simulated health, simulated treasure, and/or other items of simulated value, one or more of those items being transferred from the second user to the first user as a result of the first user successfully scoring a hit upon the second user. In this way, a transfer of simulated value is performed from the second user to the first user as a result of the first user successfully targeting and scoring a hit upon the second user.

If the first user had requested communication with a targeted user and is determined to have communication initiation access authorization with that targeted user, the UTA server may enable communication from the first user to the targeted second user. This may be achieved by the UTA server routing a communication message and/or communication request from the first user to the targeted user. Alternately this may be achieved by sending communication authorization data and/or communication routing data to the first user enabling the first user to communicate directly with the second user without being routed through the UTA server. In some embodiments this is achieved in whole or in part by the UTA server sending a phone number, email address, instant messaging address, alias, or other similar identifier about the targeted user to the first user so that the first user can initiate communication with the targeted user.

The targeting methods as disclosed herein operate in four basic operational steps—the first step is the transmission of positional data from each of a plurality of portable gaming devices to the UTA server, the positional data representing the then current geographic location of each of the portable gaming devices. This data is generally accessed from a GPS transceiver local to the portable gaming device and is represented as spatial coordinates such as longitude, latitude, and optionally elevation values. This data may also include one or more orientation values for each portable gaming device and/or the user of each portable gaming device. In one such embodiment a facing-orientation is reported for the user of each portable gaming device, the facing-orientation reflecting the spatial orientation at which the user is currently facing, for example with respect to magnetic north. This data is generally detected by a magnetometer on the person of the user, for example worn on the belt of the user or shoe of the user in a known orientation. Such a worn magnetometer generally communicates orientation data to the portable gaming device over a local wireless network, such as Bluetooth. The portable gaming device in turn communicates the facing-orientation data for the user to the UTA server over a long range wireless network.

In this way, each portable gaming device communicates positional data representing its current geographic location and optionally a current facing-orientation of its user to the UTA server. This step is repeatedly performed at a rapid rate such that the UTA server receives repeatedly updated and substantially current data about the location and orientation of the plurality of portable gaming devices. The location information, preferably spatial coordinates such as GPS coordinates of high resolution and accuracy, are stored in a tracking database by the UTA server. In some embodiments orientation values are also stored in a tracking database the UTA server. The tracking database may also store a history of the location information for each of the plurality of portable gaming devices. The tracking database may also include predictive location information for some or all of the plurality of portable gaming devices, the predictive location information representing an anticipated location coordinate for a portable gaming device as determined from current and/or historical location information and/or from velocity information for a portable gaming device.

Although there are many ways it may be maintained, the tracking database includes substantially current information that represents the location of each of a plurality of portable gaming devices based substantially upon positional data received by the UTA server over a communication link.

The second, third, and forth operational steps of embodiments of the present invention are related to the specific targeting operation performed by a first user when seeking to score-a-hit upon one or more other users. These steps are generally performed in response to the first user initiating a targeting sequence by aiming his or her portable gaming device (or a portion thereof) at the then current visible location of one or more other users within his or her physical space and engaging a user interface option upon his or her portable gaming device. The steps are described below.

The second step is the reading of position and orientation sensors local to a portable gaming device of the first user, with the position and orientation sensors including, for example, a GPS sensor and other orientation sensors such as an accelerometer and/or magnetometer as described in further detail below. The orientation sensor used in this step is local to the portable gaming device such that it detects the orientation of the aiming portion of the portable gaming device when targeting is being performed by the first user. In this way the magnetometer orientation data indicates the aiming orientation of the portable gaming device (or a portion thereof) when aimed at one or more other users of enabled portable gaming devices. Thus, the reading of the sensors provides a positional coordinate and orientation direction for the portable gaming device as positioned by the user. In one preferred embodiment the portable gaming device is a handheld unit that can be freely aimed by the user at a target remote location in space. A variety of aiming tools and methods may be employed to assist in aiming at a remote target such as the optical projection and optical imaging methods which are described in co-pending patent application Ser. Nos. 11/344,612, 11/315,755, and 11/344,701 by the present inventor, the disclosures of which are herein incorporated by reference.

When the portable gaming device is aimed at a target user and/or a group of target users the user presses a button, performs a gesture, utters a word or phrase, or otherwise indicates to the portable gaming device that the device (or a portion thereof) is aimed at one or more targeted users. Based upon the button press or other indication by the user that the device is aimed as desired, the software running upon the portable gaming device reads the position and orientation sensors to determine current positional coordinates and current targeting vector for the portable gaming device. This completes the second step.

The third step is the determination of a targeting area within the real physical world based upon the current positional coordinates, the current targeting vector, as well as optional values such as angular range values and/or targeting distance values for the current targeting operation. Because the targeting vector is determined as an angular vector originating at the current positional coordinates of the first user and pointing away from the user in the direction that the portable gaming device was aimed during targeting, the targeting area is generally defined as an area starting from a location at or near the current positional coordinates of the first user and extending away from that user in the direction of the targeting vector. The area is defined around the targeting vector by some angular range value, for example, plus or minus 10 degrees, or as an otherwise defined area or volume around the targeting vector. The area may extend indefinitely away from the first user in the direction of the targeting vector, or may have a limited range as defined by one or more targeting distance values. Thus a targeting distance is optionally determined as a distance away from the current positional coordinates of the first user that a targeting area extends, in the direction of the targeting vector. The targeting distance may be described as a range of values, including a minimum distance and a maximum distance.

The fourth step is a determination by the UTA server is a determination as which user or users are being targeted by a targeting operation of the first user and whether or not the first user has scored-a-hit upon the targeted user(s). In general this is performed by determining which other users, if any, currently reside at a spatial location within the real physical world that corresponds to a location within or upon the defined targeting area for a given targeting operation. In some embodiments only a single user may be targeted as determined based on which user falls closest to the targeting vector generated by the first user during the targeting process (i.e., falls most central within the targeting area) and/or is based upon which user within the targeting volume resides closest to the first user (i.e., the nearest user along the general direction of the targeting vector). In alternate embodiments a plurality of users may be targeted, for example all those users falling within the targeting area.

The fourth step may have a number of sub-steps. In sub-step (A) the UTA server identifies each of the targeted user(s) who fall within the target area based upon their current geographic location as stored within the tracking database. In sub-step (B) the UTA server determines if a hit is scored upon each of the target users based upon the distance between that user and the first user, the presence of any intervening barriers between that user and the first user (as also stored in an accessible database), the use and/or strength of any shields used by the targeted user(s) and/or the first user, and/or the degree to which the targeting vector comes within proximity of the current location of the targeted user. In addition personal profile information may also be considered in determining if a hit is scored upon a user, the personal profile information including for example team affiliations of the first user and/or targeted user. In sub-step (C) the UTA server determines based upon the information accessed in sub-step (B) the effect that may result from the first user scoring a hit upon a second user. This may include determining any increase in score or other gaming advantage awarded to the first user. This may also included determining any decrease in score, decrease in health, decrease in shield levels, and/or other decrease in gaming advantage imposed upon the second user. In sub-step (D), a message may be communicated from the first user to the targeted user and/or real-time communication may be initiated between the first user and the targeted user.

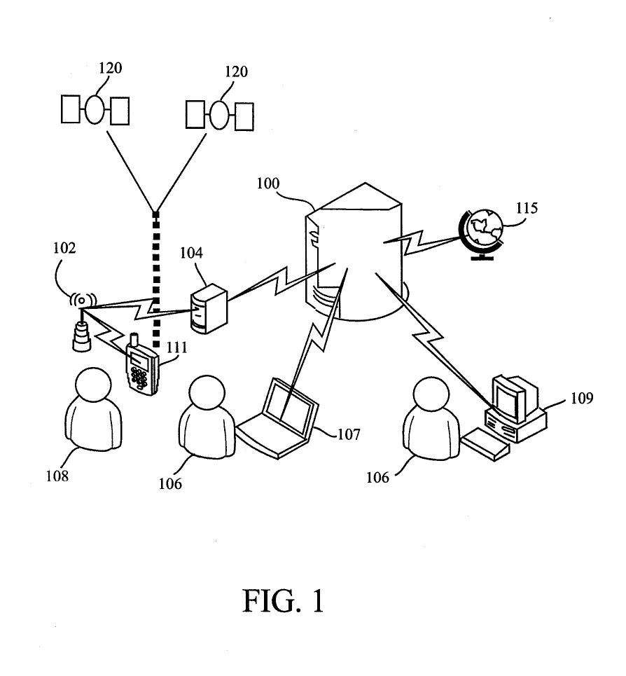

FIG. 1 illustrates a UTA server 100, which is connected or connectable to one or more networks for implementing a managed service (e.g., in an ASP model) according to an embodiment of the invention. For illustrated purposes, the UTA server 100 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described below. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment. As illustrated FIG. 1, the UTA server 100 may be in communication with a mobile service provider (MSP) 102 through a gateway, such as SMS gateway 104.

As also illustrated in FIG. 1, one or more users 106 register for the service, typically by using a client machine which may be the portable gaming device 111 or some other machines such as a laptop 107 or desktop computer 109. When a desktop computer is used, registration is initiated by an end user opening a Web browser to the operator's Web site registration page (or set of registration pages). When a portable gaming device is used, registration may be initiating through a mini-browser or other similar interface. These techniques are merely representative, as any convenient technique (including, without limitation, email, filling out and mailing forms, and the like) may be used. Thus, in the illustrated embodiment, users register with the UTA server 100 (or set of servers) either through Internet connections from personal computers, or via remote registration through a mobile device.

Also illustrated in FIG. 1 is a GPS 120 for use in tracking the location of portable gaming devices such as portable gaming device 111. GPS technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar GPS will be discussed with reference to embodiments of the invention. However, other positioning systems are also contemplated for use with the present invention, including newer versions of GPS that provide better accuracy and improved usage indoors.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information, one or more sensors may be included within or affixed to the portable gaming device. Some sensors can provide tilt information with respect to the gravitational up-down direction. Other sensors can provide orientation information with respect to magnetic north. For example, an accelerometer may be included to provide tilt orientation information about the portable gaming device in one or two axes. In some embodiments a single axis accelerometer is used that senses the pitch angle (tilt away from horizontal) that the portable gaming device is pointing. In other embodiments a 2-axis accelerometer can be used that senses the pitch angle (tilt away from horizontal) that the portable gaming device is pointing as well as the roll angle (left-right tilt) that the portable gaming device is pointing. A suitable accelerometer is model number ADXL202 manufactured by Analog Devices, Inc. of Norwood Mass. To sense the orientation of the portable gaming device with respect to magnetic north, a magnetometer is included. In one embodiment a 3-axis magnetometer model number HMC1023 manufactured by Honeywell SSEC of Plymouth, Minn. is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable gaming device. All of the orientation sensors may all be housed within the casing of the portable gaming device and be connected electronically to the microprocessor of the portable gaming device such that the microprocessor can access sensor readings and perform computations based upon and/or contingent upon the sensor readings.

Also, as discussed above the system may be configured with a second orientation sensor (for example, a second magnetometer) that is worn by the user (for example, on or within a belt or shoe or other article of clothing) such that it maintains a known orientation with respect to the user. Such a magnetometer may be configured with its own local processor and communication interface such that it communicates orientation data for the user to the portable gaming device or directly to the UTA server. In a preferred embodiment the user worn magnetometer is affixed to the user's belt or shoe in a known orientation such that orientation data can be used to determine the user's facing direction. This facing orientation data is communicated over Bluetooth communication link to the portable gaming device. In this way the portable gaming device has two orientation values, a targeting orientation value that indicates the direction that the portable gaming device is pointing when being aimed by a first user at another remote user and a facing orientation value that indicates the facing direction of the first user.

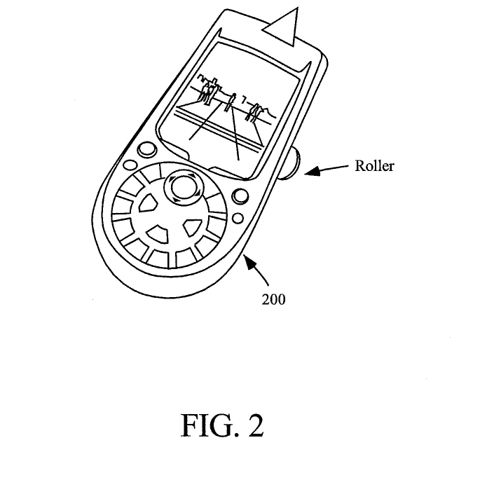

FIG. 2 illustrates a portable gaming device 200 configured with appropriate hardware and software according to an embodiment of the invention. The portable gaming device includes a wireless communication link to an information network such as the Internet. The portable gaming device also includes a differential GPS transceiver for sensing the devices geographic location with a high degree of accuracy. The portable gaming device also includes one or more orientation sensors such as a magnetometer for sensing geometric orientation with respect to geographic north and such as an accelerometer for sensing pitch angle of the device with respect to the gravitational horizontal. Also the portable gaming device is shaped such that it can be conveniently pointed at a remote person during gaming targeting actions. Also the portable gaming device may include targeting methods and/or technologies for more easily targeting a distant person aimed at by the user. The portable gaming device may optionally include a finger controllable roller on the side for use with scrolling and other functions associated with embodiments of the invention.

As depicted in FIG. 2, the portable gaming device includes a casing having a physical shape (in some preferred embodiments) with a defined pointing end. Inside the casing, the portable gaming device includes a microcontroller, a wireless communication link such as the aforementioned RF transceiver, and position and orientation sensors which are connected to the microcontroller, and a power supply (e.g., batteries) for powering these electronic components. The portable gaming device may also include other electronic components such as a user activated switches or buttons or levers or knobs or touch screens or microphones or speakers or LCD displays or lights or graphical displays. These components, which are also connected to the microcontroller, are employed for the purpose providing information display to users and/or for allowing the user to provide input to the system. These input and output components are collectively referred to as the User Interface (UI) of the portable gaming device. The portable gaming device also includes hardware and/or software for enabling a user to send and receive communications with other uses such as a microphone and speaker for voice communication and/or a keyboard and screen for text communication.

As used herein, “portable gaming device” should be broadly construed as including any mobile wireless client device, e.g., a cellphone, pager, a personal digital assistant (PDA, e.g., with GPRS NIC), a mobile computer with a smartphone client, or the like. The portable gaming device may also be a dedicated gaming device such as a Gameboy or other game focused portable computing unit. A typical portable gaming device employed by the current invention is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including Cellular digital packet data (“CDPD”), Code division multiple access (“CDMA”), Global System for Mobile Communications (“GSM”), Personal Digital Cellular (“PDC”), Personal Handy-phone System (“PHS”), Time division multiple access (“TDMA”), FLEX, ReFLEX, Integrated Digital Enhanced Network (“iDEN”), TErrestrial Trunked RAdio (“TETRA”), Digital Enhanced Cordless Telecommunications (“DECT”), DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over General Packet Radio Service (“GPRS”), which is a data technology for GSM networks. In addition to a conventional voice communication, a given mobile device can communicate with another such device via many different types of message transfer techniques, including short message service (“SMS”), enhanced SMS (“EMS”), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable gaming device. Embodiments of the 1.5 present invention are not limited to mobile device users who have WAP-enabled devices or to use of any particular type of wireless network. Such devices and networks are merely illustrative; any wireless data communication technology now known or hereafter developed may be used in connection with the invention that is now described in more detail

In some embodiments, the portable gaming device includes basic telephone features such as a dial pad and a handset configuration with microphone and speaker. The portable gaming device includes a computer processor, an information display, a user interface, and a wireless communication link to an information network such as the Internet. The portable gaming device also includes a differential GPS transceiver for sensing the geographic location of the portable gaming device with a high degree of accuracy. The GPS receiver receives signals from three or more GPS transmitters and converts the signals to a specific latitude and longitude (and in some cases altitude) coordinate as described above. The GPS receiver provides the coordinate to the software running upon portable gaming device and/or to software running upon the UTA server. Additional orientation sensors provide orientation data to software running upon the portable gaming device and/or the UTA server, the orientation data indicating the direction at which the portable gaming device is pointing when aimed at another user (or group of users) by the user. Additional ranging technology may be included (not shown), the ranging technology used by the user to determine, estimate, and/or indicate the line-of-sight distance or a range of distances to targeted user(s).

The user of the portable gaming device aims the device at another user using one or more targeting methods and technologies described herein. In the most basic embodiment, the shape of the casing of the portable gaming device (or a portion thereof) is provided to assist in targeting distant users. For example, a pointed shape on the aimable portion of the casing makes it easier for the user to aim the appropriate portion of the portable gaming device at distant users. In other embodiments, additional tools and technologies are employed to assist a user in aiming the portable gaming device at distant users. For example, a targeting device such as digital camera or integrated laser pointer may be used to assist the user in aiming the device. The user aims the targeting device at a desired distant user (or group of users) and presses a button (or other user interface) upon the portable gaming device to indicate that the device is currently aimed. The software running upon the portable gaming device then computes a targeting vector for the targeted user (or group of users). The targeting vector may be derived in whole or in part using the magnetometer which gives an orientation vector with respect to magnetic north. The direction may also include a pitch angle with respect to the gravitational horizontal. This pitch angle can be derived from the sensor data collected from an on board accelerometer (or other tilt sensor). The targeting vector along with the current positional coordinate of the targeting user are transmitted to the UTA server over the wireless communication link when a targeting operation is performed by the user. The UTA server uses this information to identify the targeted user(s) based upon location information of current users stored in a tracking database. This process is described in further detail below. Once the targeted users(s) are identified by the UTA server, software running upon the UTA server and/or the portable gaming device of one or more users then determines if a hit was scored by the targeting user and/or the result of the hit. For example, the software may determine if a hit was scored by the targeting user upon the targeted user if the targeted user falls substantially within the path of the targeting vector as it emanates from the spatial location of the targeting user towards the targeted user. By substantially within the path, it is meant that the targeting user falls within a certain range or area around the targeting vector as it emanates from the targeting user towards the targeted user. In some embodiments the time duration of the targeting is also considered, the time duration being the period of elapsed time during which the targeted user remains substantially within the path of the targeting vector as it emanates from the targeting user towards the targeted user. In general the time duration is limited to the time that the targeting user maintains the portable gaming device pointed at the targeted user and engages the appropriate user interface element to engage targeting.

The software may also consider other real and simulated factors when determining if a score was hit by the targeting user upon the targeted user. Such factors may include (a) the simulated status and/or strength level of simulated shields currently being used by the targeted and/or targeting users, (b) the presence and/or configuration and/or geometry of intervening simulated barriers between the targeting user and the targeted user, (c) the real facing direction of the targeted user with respect to the targeting vector, (d) the real spatial distance between the targeting user and the targeted user within the real physical world, (e) the simulated ammunition type, ammunition level, weapon type, power level, strength level, heath level, team affiliation, character type, or other simulated characteristic of the targeting user, and/or (f) the simulated shield type, shield level, power level, strength level, health level, team affiliation, character type, or other simulated characteristic of the targeted user.

The UTA server then determines, based upon the information, whether the targeting user scores a hit upon one or more targeted users and if so, the result of the hit. In general, the result of the hit involves the targeting user achieving some degree of gaming advantage with respect to the targeted user. For example, the targeting user may be awarded points or other gaming advantage units such as strength, treasure, health, power, ammunition, or shield intensity. Similarly, the targeted user may be reduced by some number of points or other gaming advantage units such as strength, treasure, health, power, ammunition, or shield intensity. Also, in general, when a targeting user targets another user, he or she expends some amount of simulated ammunition relating to the duration and/or number of times he or she targeted other users.

If it is determined that the targeting user has successfully targeted another user and scored a hit, the targeting user may be provided with information about the targeted user and/or may be enabled to initiate communication with the targeted users. For example, the targeting user may be provided with identity information, simulated status information, simulated character information, score information, health information, ammunition information, team information, and/or other stored information about the targeted user. In this way the targeting user is provided with information that tells him or her who he or she hit, what his or her gaming status was, and what the result of the hit was.

If it is determined that a user was successfully targeted by another user who scored a hit upon that user, the targeted user may be provided with information about the targeting user and/or may be enabled to initiate communication with the targeting users. For example, the targeted user may be provided with identity information, simulated status information, simulated character information, score information, health information, ammunition information, team information, and/or other stored information about the targeting user. In this way the targeted user may be provided with information that tells who just scored a hit upon him and provides some gaming information about that user.

If the targeting user is determined to be provided with information about a targeted user, that information may be transmitted by the UTA server to the portable gaming device of the targeting user. The information is then displayed to the targeting user by the visual and/or audio display features of the portable gaming device. If a targeting user requests communication with a targeted user and is determined to have communication initiation access authorization with that targeted user, the UTA server enables communication from the targeting user to the targeted user. This may be achieved by the UTA server routing a communication message and/or communication request from the targeting user to the targeted user. Alternately this may be achieved by sending communication authorization data and/or communication routing data to the targeting user enabling the targeting user to communicate directly with the second user without being routed through the UTA server. In some embodiments this is achieved in whole or in part by the UTA server sending a phone number, email address, instant messaging address, alias, or other similar electronic identifier about the targeted user to the targeting user so that the targeting user can initiate communication with the targeted user.

Because a user may wish to target a particular person in an environment filled with a plurality of persons and because GPS and other sensors have limited accuracy and resolution, an important aspect of the present invention is the ability to target distant user(s) that are within certain proximity of a targeting vector as it extends from the location of the targeting user towards potential targeted users. This is achieved by defining or otherwise specifying an angular range or area around the targeting vector and/or a distance range from the targeting user for which targeted users will be considered by the UTA server. In this way targeting accuracy limitations can be accommodated. In addition, the effective angle and range of the targeting performed by a targeting user can be limited to a maximum based upon gaming configuration values, gaming status values, and/or other simulated events or properties within the gaming action. For example, a targeting user who is using a particular simulated weapon may be enabled to score a hit upon targeted users who fall within a certain angular range (or area) around the targeting vector AND who fall within a certain distance range from the targeting user along the direction of the targeting vector. Different simulated weapons may be associated with different angular ranges and/or areas around the targeting vector. In addition, different simulated weapons may be associated with different distance ranges. In addition, simulated shields used by either or both the targeting user and the targeted user may influence the effective angular range or area about a targeting vector within which the targeting user may score may be hit upon the targeted user. In addition, simulated shields used by either or both the targeting user and the targeted user may influence the effective distance range within which the targeting user may score a hit upon the targeted user.

In some preferred embodiments the users can set or otherwise select the angular range values and/or distance range values by accessing a menu driven interface upon the portable gaming device. In this way, users can select gaming parameters that dictate how accurately a user must target another user to score a hit. In this way a user can also select gaming parameters that dictate how near a targeting user must be to a targeted user in order to score a hit.

Thus, embodiments of the present invention enable users of a portable gaming device to engage in person to person gaming action wherein a first user targets a second user and scores a hit upon the second user if the second user resides at a real spatial location that falls within a an prescribed targeting area about the targeting vector aimed by the first user at the second user, the targeting vector being an angular vector that starts at or approximately at the real physical location of the first user and extends along an aiming direction defined by the aimable portion of the portable gaming device. The prescribed targeting area may be an angular area about the targeting vector, for example, plus or minus ten degrees. The prescribed targeting area may be a geometric area defined in other ways, for example a cylinder or cone about the targeting vector, the cylinder or cone having a particular size. The prescribed targeting area may also be limited to a targeting range, the targeting range being a maximum distance that a targeted user may reside away from the targeting user within the real physical world. The targeting range is often measured along the line defined by the targeting vector.

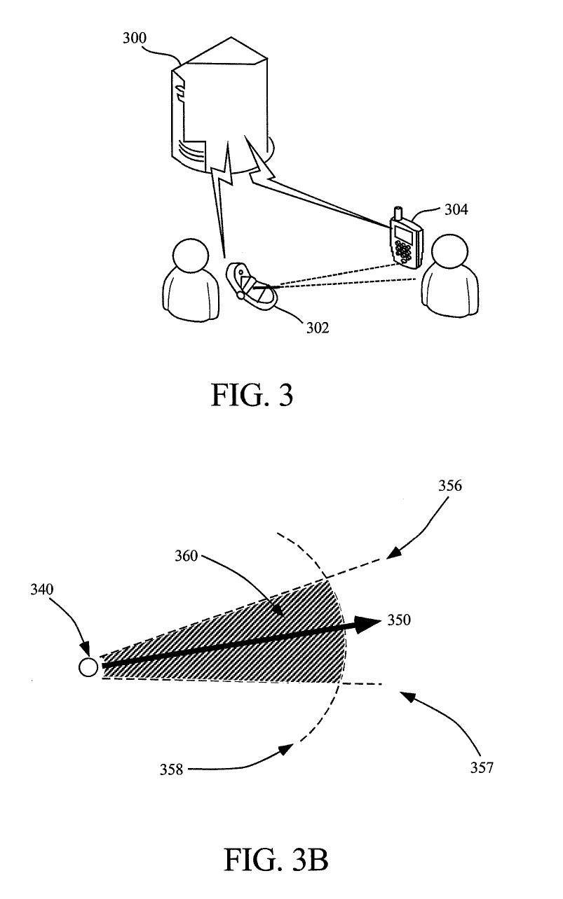

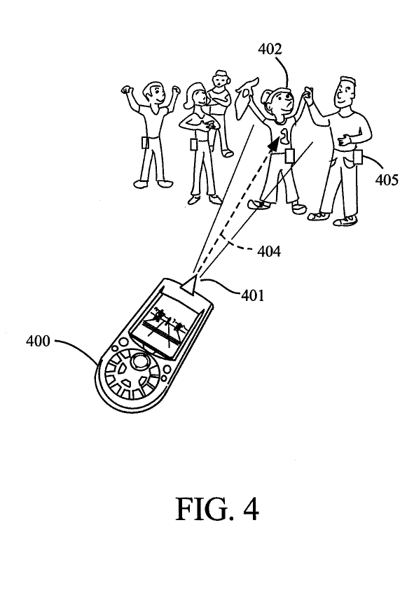

FIGS. 3, 3b, and 4 illustrates a method of operation according to an embodiment of the invention. In particular, the method enables portable gaming device users to score hits upon one another, access information about one another, and/or initiate communication with one another, by a first of the users pointing their portable gaming device (or a portion thereof) at a second of the users. As illustrated in FIG. 3, when a user of a first portable gaming device 302 targets a user of a second portable gaming device 304 by aiming his portable gaming device (or a portion thereof) at the current physical location of the user of the second portable gaming device 304 at a current moment in time, the UTA server 300 determines whether the first user scores a hit upon the second user. The determination is based upon one or more of a plurality of different factors. These factors generally include the real physical locations of the two users, the real physical aiming vector of the portable gaming device of the first user, the real physical facing direction of the second user, the intervening real physical distance between them, and/or the timing and/or duration of the targeting event. These factors generally also include simulated factors such as the simulated weapon type used by the first user, the simulated shield type and/or strength and/or level used by the second user, the presence and configuration of any simulated barriers relationally associated with any intervening locations between the first user and the second user, the simulated character types or levels or strengths associated with the first and/or second users, the simulated team affiliations of the first and/or second users, the type or usage of any simulated shields by the first user, the type and/or quantity of simulated ammunition used by the first user.

A critical step in the determination of whether or not the first user scores a hit upon the second user is the determination of whether the first user has sufficiently targeted the second user by pointing his portable gaming device (or a portion thereof) at the current physical location of the second user as determined by the UTA server which receives location information about a plurality of users and stored them in a tracking database. By sufficiently targeted it means that the real physical location of the second user falls within a particular area or range about the targeting vector during the targeting operation. By sufficiently targeted it may also mean that the real physical location of the second user falls within a particular distance range from the first user. As mentioned previously, the targeting vector is defined by the aiming direction of the portable gaming device (or portion thereof) during the targeting operation performed by the user. Thus if the first user aims his portable computing device (or a portion thereof) such that an imaginary vector extending forward and away from the first user along the aiming direction passes within certain geometric proximity of the second user AND if the two users are within a certain maximum distance away from each other, the UTA server may determine that the first user sufficiently targeted the second user. The determination of whether a hit was scored by the first user and/or the results of that hit are determined with consideration of the aforementioned simulated factors such as simulate weapon usage, shield usage, and barrier configurations as well as real factors such as the facing direction of the second user with respect to the first user and/or the targeting vector.

As shown in FIG. 3, the UTA server 300 is operative to send and receive data from a plurality of portable gaming devices, each operated by a user. The UTA server 300 is operative to send and receive data from a first portable gaming device 302 operated by a first user as well as send and receive data from a second portable gaming device 304 operated by a second user. The data received by the UTA server from each portable gaming device includes but is not limited to current positional coordinates for each of the portable gaming devices, the positional coordinates describing or otherwise indicating the substantially current geographic location of each portable gaming device. This data is generally received repeatedly at a rapid update rate. Because it is assumed that the portable gaming devices are kept local to its user (i.e. held, worn, or otherwise carried about by a user), the positional coordinates are also assumed to describe or otherwise indicate the substantially current geographic location of each of the users. In addition, one or more orientation values may be sent from each portable gaming device to the UTA server, either regularly or upon targeting events, the orientation values indicating the targeting orientation of the portable gaming device and/or the facing orientation of its user.

The UTA server 300 as shown in FIG. 3 is also operative to determine if one or more of the plurality of portable gaming devices, as operated by its user, targets one or more other of the plurality of portable gaming devices by virtue of being aimed at the geographic location of that one or more other of the plurality of portable gaming devices while its user engages an appropriate user interface function. As shown specifically in the figure, the UTA server is operative, for example, to determine if a first portable gaming device 302 as controlled by a first user targets the physical location of a second user using a second portable gaming device 304. The UTA server is further operative to determine if the first user successfully scores a hit upon the second user and/or the result of such a hit (i.e., the awarding of any gaming advantage to either user). The UTA server is further operative to moderate any subsequent information exchanges between users and/or the subsequent communication initiation between users if such exchange and/or communication are requested and/or authorized.

This process of determining if a first user successfully targets a second user and further determining if the first user scores a hit upon the second user is referred to herein as a targeting determination. The UTA server 300 generally makes this determination in a number of computational steps. In one example embodiment, the procedure follows four basic operational steps as described above. For a particular example embodiment, these four steps are described in more detail below.

The first step is the transmission of current positional coordinates from each of a plurality of portable gaming devices to the UTA server, the current positional coordinates representing the then current geographic location of each of the portable gaming devices. The current positional coordinates are stored by the UTA server in accessible memory and indexed such that each current positional coordinate is linked to the specific portable gaming device and/or specific user from which it was received. By current geographic location it is understood that there will generally be some amount time lag that causes the most currently received and stored location for a particular user/portable gaming device to actually reflect a location of that user/portable gaming device at a recent time in the past. It is therefore desirable for embodiments of the current invention to keep such time lags as small as possible within the practical limitations of the technology employed. This means frequent updates of current positional coordinates are sent from each portable gaming device to the UTA server. In some embodiments this is achieved by having all portable gaming devices update their location at a rapid rate such as 30 to 120 times per minute. In other embodiments an intelligent algorithm is employed such that the update rate from each portable gaming device is determined based upon the then current motion of that portable gaming device. In such an algorithm, a portable gaming device that is determined to be substantially at rest for a period of time, will report infrequent updates of its location to the UTA server while a portable gaming device that is determined to be in motion will report more frequent updates of its location the UTA server, the more rapid the motion of the gaming device, the more frequent the reporting.

In one such embodiment each portable gaming device runs an Intelligent Reporting Algorithm upon a local processor, the Intelligent Reporting Algorithm accessing data from local positional and/or motion sensors and determines based upon such data if the portable gaming device is in motion and if so the current rate of motion. For example, in one such embodiment the Intelligent Reporting Algorithm upon each portable gaming device accesses data from GPS sensors local to each portable gaming device at regular rapid intervals and computes based upon a time history of such data, a current speed estimation for the portable gaming device in one or more directions. The Intelligent Reporting Algorithm then determines a reporting rate of positional data to the UTA server based upon the current speed estimation. If the speed estimation is zero or low because a user is, for example, sitting or standing still—a slow reporting rate will be determined. For example, one report every two minutes. If the speed estimation is high because the user is, for example, walking or running—a faster reporting rate will be determined such as, for example, 100 to 400 reports per minute. If the speed estimation falls somewhere in between, the reporting rate may be scaled accordingly to an intermediate value. Thus, by dynamically adjusting the reporting rate from each portable gaming device based upon the currently estimated speed of motion of that portable gaming device within the real physical world, this inventive method helps to better utilize available communication bandwidth, providing rapid reports from those user that require rapid reports for accurate tracking and infrequent reports from those users that do not require rapid reports for accurate tracking.

Some embodiments of the present invention enable each portable gaming device to report its current speed or velocity estimation to the UTA server along with its current positional coordinates during some or all updates. The speed or velocity reports are then used by the UTA server in such embodiments to account for positional errors caused by time-lag. This is performed through an inventive Predictive Tracking Algorithm in which a more accurate current location of a portable gaming device is predicted based upon its reported current location (which is subject to time lag) and the reported velocity estimation associated with that reported current location. The Predictive Tracking Algorithm computes the more accurate current location of a portable gaming device by adding a predictive spatial offset to the reported current location of that portable gaming device, the predictive spatial offset being computed based upon the reported velocity estimation and the known or estimated time lag between the report and the current time. For example, if a portable gaming device reports its current location as X,Y,Z in some units U. The portable gaming device may report its current estimated velocity in units of U/sec to be Vx in the X direction, Vy in the Y direction and Vz in the Z direction. And if it is known (or estimated) that a (t) second time lag is present between the time when the data was collected and the current time the data is being processed by the UTA server, a more accurate current location can be predicted by adding an offset equal to the estimated current velocity V multiplied by known or estimated time lag (t) as follows: (X+Vx t), (Y+Vy t), (Z+Vz t).

To support accurate time lag computations or estimations, some embodiments of the present invention enable portable gaming devices to also report a time-stamp value to the UTA server along with the report of current positional coordinates. The time-stamp value indicates or otherwise represents the time at which the current positional coordinate was collected. This value is then used by the UTA sever to determine the time lag between when the most recently current positional coordinate was reported from a given portable gaming device and the then current time at which targeting computations are being performed. In this way the UTA server can more accurately perform a predicative update of positional coordinate is when performing a targeting determination.

Thus, some embodiments of the present invention are configured such that each portable gaming device reports to the UTA server its most current positional coordinates, its most current velocity estimation, a time-stamp indicating when the positional coordinates were collected, and unique identifier enabling the UTA server to correlated the received data with a particular portable gaming device and/or particular user. Some or all of this data is then stored in a tracking database for the plurality of users. In some embodiments in which the portable gaming device does not report a time stamp, the UTA server may be configured to store its own time-stamp for data received, the UTA server time-stamp indicating the time at which a current positional coordinate was received from a particular portable gaming device. Such a time-stamp is generally not as accurate as one generated by a portable gaming device itself for there may be communication and processing delay that is not accounted for, but using this method reduces the amount of information that need be communicated over the communication link and therefore helps preserve communication bandwidth.

In some embodiments of the present invention the UTA server also stores a time-history of current geographic locations for the plurality of users, the time-history reflecting one or more previous but recent locations of each of the plurality of users. Furthermore, in some embodiments of the present invention the UTA application may be operative to predict a current location of a user based at least in part upon the stored time-history of previous locations of that user, for example by deriving a velocity from the stored time-history of locations of that user and computing an offset based upon the derived velocity and a known or estimated time lag. For example, if the UTA server receives a current location from a portable gaming device as X,Y,Z in some units U. And if the UTA server computes an estimated current velocity for that portable gaming device based upon a time-history of stored location data for that portable gaming device. And if the estimated current velocity (V) in units of U/sec are determined to be Vx in the X direction, Vy in the Y direction and Vz in the Z direction. And if it is known (or estimated) that a (t) second time lag is present between the time when the data was collected and the current time the data is being processed by the UTA server, a more accurate current location can be predicted by adding an offset equal to the estimated current velocity V multiplied by the time lag (t) as follows: (X+Vx t), (Y+Vy t), (Z+Vzt).

Some embodiments of the present invention are configured such that each portable gaming device also reports one or more orientation values to the UTA server along with the positional coordinates described above. In a preferred embodiment the orientation value is reflective of the user's facing direction at the current moment in time. As described above, the facing direction data may be provided as an angular orientation with respect to magnetic north, and may be derived by the portable gaming device through the use of an orientation sensor, such as a magnetometer. In some preferred embodiments the magnetometer may be remotely located upon the person of the user, for example affixed to his or her belt, clothing, or shoe, in a known orientation such that the data reflects a facing direction for the user with respect to the physical world. Thus, as a user changes his or her facing direction with respect to his or her surroundings, the orientation data changes accordingly. For embodiments that use a remote body worn magnetometer, the sensor may be interfaced by wireless link (for example Bluetooth) to the portable gaming device of the present invention. The portable gaming device then relays this data, or a derivation based upon this data, to the UTA server for use in gaming determinations such as for use in determining if one or more other user's scores a hit upon that user.

Thus, in first step of the targeting determination process, there are a variety of ways in which the UTA server may receive and store positional and/or orientational data from each portable gaming device in a tracking database, the positional data including current positional coordinates for that portable gaming device and optionally including velocity data and/or time-stamp data and/or historical data for that portable gaming device. This step is repeatedly performed at a rapid rate such that the UTA server receives repeatedly updated and substantially current data about the location (and optionally orientation) of the plurality of portable gaming devices and/or its user. The second, third, and forth operational steps of the present invention are related to the specific targeting operation performed by a first user when seeking to score a hit, gain information about, and/or initiate communication with one or more other users (in this example, the second user). These steps are generally performed in response to a user targeting another user using his or her portable gaming device. The first user initiates the targeting operation by aiming his or her portable gaming device (or a portion thereof) at the then current visible location of the second user while engaging a user interface option upon his or her portable gaming device. The steps which are then performed are as discussed below.

The second step is the reading of position and orientation sensors local to a portable gaming device of the first user, the position and orientation sensors including for example a GPS sensor and other orientation sensors such as an accelerometer and/or magnetometer to be described in more detail later. The orientation sensor used in this step is local to the portable gaming device such that it detects the orientation of the aiming portion of the portable gaming device when targeting is being performed by the first user. In this way the magnetometer orientation data indicates the aiming orientation of the portable gaming device (or a portion thereof) when aimed at one or more other users of enabled portable gaming devices. Thus the reading of the sensors provides a positional coordinate and orientation direction for the portable gaming device as positioned by the user. In one preferred embodiment the portable gaming device is a handheld unit that can be freely aimed by the user at a target remote location in space. A variety of aiming tools and methods may be employed to assist in aiming at a remote target such as the optical projection and optical imaging methods which are described in co-pending patent application Ser. Nos. 11/344,612, 11/315,755, and 11/344,701 by the present inventor, the disclosures of which are herein incorporated by reference.

When the portable gaming device is aimed at a target user and/or a group of target users the user presses a button, performs a gesture, utters a word or phrase, or otherwise indicates to the portable gaming device that the device (or a portion thereof) is aimed at one or more targeted users. Based upon the button press or other indication by the user that the device is aimed as desired, the software running upon the portable gaming device reads the position and orientation sensors to determine current positional coordinates and current targeting vector for the portable gaming device. The current positional coordinate describes the first user's location within the real physical world, often as geospatial coordinates. The current targeting vector describes the current aiming orientation of the portable gaming device (or aimable portion thereof) within the real physical world. In general the targeting vector is a mathematical vector that points from the current positional coordinate location, away from the user, in the direction defined by the aiming orientation of the portable gaming device (or portion thereof) when the targeting step was performed. This completes the second step.

The third step is the determination of a targeting area within the real physical world based upon the current positional coordinates, the current targeting vector, as well as optional values such as angular range values and/or targeting distance values for the current targeting operation. There are many ways in which the targeting area may be defined, but generally it is defined as an area or volume around the targeting vector and extending away from the targeting user along the direction of the targeting vector for some distance. One example definition of a targeting area is shown with respect to FIG. 3b. FIG. 3b shows an overhead view of a targeting area. The targeting area (360) is represented as a shaded region of a roughly pie-slice shaped configuration. This area may be planer or may be defined as a volume extending into and/or out of the page. The targeting area (360) shown is drawn to correspond with the first user of the first portable gaming device 302 in FIG. 3 herein as that user targets a second user of a second portable gaming device 304. As shown in FIG. 3b, a targeting vector (350) is defined based upon the orientation data collected for the portable computing device of the first user as it was held during the targeting operation. As also shown in FIG. 3b, a set of positional coordinates 340 are defined based upon the positional data collected for the portable computing device of the first user at the time when the targeting operation was performed. Thus as shown in FIG. 3b, the targeting area (360) is defined as a spatial area (or volume) around the targeting vector (350) that starts from a location at or near the set of positional coordinates 340 and extends outward away from the targeting user in the direction of the targeting vector (350). The area may extend indefinitely in the direction of the targeting vector or may be limited by one or more targeting distance values. In this embodiment, the targeting area is limited by a Maximum Targeting Distance (358) value. In alternate embodiments a Minimum Targeting Distance (not shown) may also be used in defining the targeting area. In general there are numerous ways in which the targeting area may be defined as an area or volume around the targeting vector (350). In this embodiment it is defined by an angular range of plus or minus ten degrees about the targeting vector. The plus and minus angular range limits are shown in the figure as (357) and (356) respectively.

The third step is the determination of targeting vector(s), targeting distance(s) and/or targeting coordinate(s) for a specific target user or group of target users as defined by the aiming of the portable gaming device by the first user. The targeting itself is likely performed by the first user using one or more inventive targeting tools and/or targeting methods (to be described later). A targeting vector is determined as an angular vector originating at the current positional coordinates of the first user and pointing in the direction that the portable gaming device was aimed during targeting. A targeting distance is determined as a distance away from the current positional coordinates of the first user that a target user is positioned. A targeting coordinate is a spatial coordinate representing the targeted location of a target user as determined by adding an offset to the current positional coordinates of the first user, the offset being in a direction defined by a targeting vector and of a distance defined by a targeting distance. In some embodiments of the present invention, one or more range values is also determined for each targeting operation, the range values including one or more of an angular range value or a distance range value. An angular range value defines a range of acceptable angles around a targeting vector, for example +/−5 degrees, within which a targeted user may reside. A distance range value is a range of acceptable distances around a targeting coordinate, for example +/−10 feet, within which a targeted user may reside. In some embodiments a plurality of range values may be computed for a plurality of different directions, including for example a minimum value and a maximum value. Finally it should be noted that a plurality of targeting vectors, targeting distances and/or target coordinates may be determined during a particular targeting operation if a plurality of users are identified by the first user.

The forth step is a determination by the UTA server is a determination as which user or users are being targeted by a targeting operation of the first user and whether or not the first user has scored-a-hit upon the targeted user(s). In general this is performed by determining which other users, if any, currently reside at a spatial location within the real physical world that corresponds to a location within or upon the defined targeting area for a given targeting operation. In some embodiments only a single user may be targeted as determined based on which user falls closest to the targeting vector generated by the first user during the targeting process (i.e. falls most central within the targeting area) and/or is based upon which user within the targeting volume resides closest to the first user (i.e. the nearest user along the general direction of the targeting vector). In alternate embodiments a plurality of users may be targeted, for example all those users falling within the targeting area.

This forth step may have a number of sub-steps. In sub-step (A) the UTA server identifies each of the targeted user(s) who fall within the target area based upon their current geographic location as stored within the tracking database. In sub-step (B) the UTA server determines if a hit is scored upon each of the target users based upon the distance between that user and the first user, the presence of any intervening barriers between that user and the first user (as also stored in an accessible database), the use and/or strength of any shields used by the targeted user(s) and/or the first user, and/or the degree to which the targeting vector comes within proximity of the current location of the targeted user. In addition personal profile information may also be considered in determining if a hit is scored upon a user, the personal profile information including for example team affiliations of the first user and/or targeted user. In sub-step (C) the UTA server determines based upon the information accessed in sub-step (B) the effect that may result from the first user scoring a hit upon a second user. This may include determining any increase in score or other gaming advantage awarded to the first user. This may also included determining any decrease in score, decrease in health, decrease in shield levels, and/or other decrease in gaming advantage imposed upon the second user. In sub-step (D), a message may be communicated from the first user to the targeted user and/or real-time communication may be initiated between the first user and the targeted user.

Referring back to steps above, the UTA server may identifies which user or users are hit based on a number of computational processes. In one computational process the UTA server computes an offset from the current positional of the first user in the direction of a targeting vector and determines the one or more users who reside on or near the line defined by the targeting vector. In an alternate computational process the UTA server computes an offset from the current positional of the first user along the direction of a targeting vector and determines the one or more users who reside within an angular targeting range around the targeting vector. In an alternate computational process the process the UTA server computes an offset from the current positional of the first user along the direction of a targeting vector and determines the one or more users who reside on or near the line defined by the targeting vector AND who are nearest in absolute spatial distance from the first user. In an alternate computational process the UTA server computes an offset from the current positional of the first user along the direction of a targeting vector by a distance equal to a targeting distance and determines the one or more users who reside on or near the point defined by the offset. In an alternate computational process the UTA server computes an offset from the current positional of the first user along the direction of a targeting vector by a distance equal to a targeting distance and determines the one or more users who reside within a targeting range of the point defined by the offset.

In many embodiments of the present invention, a portable gaming device user when targeted by another, may accept or decline the communication with the targeting user by interacting with the user interface upon his or her portable gaming device. In many embodiments the UTA server moderates the communication initiation by transmitting information between the users in a manner that masks personally identifying information thereby preserving user anonymity.

With respect to user registration, a portable gaming device user registers for the service provided by the present invention. Typically the user is prompted to fill database fields providing personal and/or professional details including, without limitation, age, gender, interests, school affiliation, team affiliation, music preferences, sports team preferences, city of residence and the like. The user also outlines the profile and/or characteristics of people the user would like to interact with through the service and/or people the user would not like to interact with through the service.

Embodiments of the invention provide targeting methods and apparatus. As described herein, the hardware employed by embodiments of the current invention enable such person-to-person pointing-based interactions incorporates position sensor technology such as GPS that tracks the geographic location of the portable gaming device as carried about by each of the users. As also disclosed herein the hardware employed incorporates orientation sensor technologies such magnetometers and accelerometers that track the orientation of the portable gaming device, the orientation indicating the direction that the portable gaming device (or a portion thereof) is pointing as held by the user. The magnetometer and accelerometers can determine the spatial orientation with respect to magnetic north as well as the spatial orientation with respect to the downward direction due to gravity. In this way the software running upon the portable gaming device can determine not only where the user is in the world (based upon position data collected by the GPS sensors) at particular points in time, but also what direction the user is pointing at (based upon orientation sensor data) as the user manipulates the portable gaming device (or a portion thereof) and aims it at a desired remote target. This action by the user of aiming the portable gaming device (or a portion thereof) at a particular user (or group of users) is referred to herein as targeting and involves the user pressing a button or otherwise manipulating a user interface to indicate that the portable gaming device is then aimed at a desired target user (or group of users). As also described herein, the user can through the user interface of the portable gaming device select a weapon type, ammunition type, or other simulated device type when performing a gaming targeting operation. For example, the user may select a simulated electron-beam weapon that sends a spray of simulated ammunition out in a cone shaped area when fired. Upon selecting such a simulated weapon, the routines of the present invention will customize the targeting determination with a target area within the real physical world that is adapted for the particular range and scope of the simulated weapon selected. In this way when the user presses a button or otherwise engages a user interface to cause a simulated targeted of a remote user, the software of the present invention can determine if the user scores a hit based at least in part upon the target area that has been customized with consideration of the particular simulated weapon, simulated ammunition, or simulated device selected.

In general a user may select from among a plurality of simulated weapon types, simulated ammunition types, or other simulated device types when performing a targeting operation using the gaming system of the present invention, each of the plurality being associated with a different target area size, shape, or configuration within the real physical world. In this way a user may select from among a plurality of different simulated weapon types and achieve different degrees of targeting range, angular scope, and/or spatial distribution within the real physical world. It should be noted that simulated weapon types need not be violent, including for example simulated glue guns, simulated fog sprays, simulated water blasts, and/or other simulated projectiles, fluids, beams, sprays, and the like.

To support embodiments of the present invention, additional inventive methods and apparatus may be employed to enable a user to more accurately aim the portable gaming device (or a portion thereof) at a particular user (or group of users) and press a button (or otherwise manipulate the user interface) to target the users. This is because it may be difficult for a user to know with a high degree of accuracy how well he or she is aiming the portable gaming device (or a portion thereof) at a particular user (or group of users) that is some distance away from where the user is standing. In addition there may be many potential target users in close proximity, only one of some of whom a user desires to target. To satisfy this need, a number of inventive methods and apparatus have been developed that facilitate targeting such as the optical projection and optical imaging methods which are described in co-pending patent application Ser. Nos. 11/344,612, 11/315,755, and 11/344,701 by the present inventor, the disclosures of which are herein incorporated by reference.

FIG. 4 illustrates a handheld portable gaming device (400) equipped with a GPS sensor for tracking its position and one or more orientation sensors for tracking the direction that the handheld portable gaming device is aimed by the user who is holding it (not shown). The portable gaming device includes casing shape (401) that is well adapted to be pointed at remote objects. By aiming the pointed portion of the portable gaming device, the user may direct a targeting vector (404) as described previously at distant users within the real physical world. As shown, a targeting area may be defined around the targeting vector to increase the spatial area for which a hit may be scored. Thus, remote user 402 resides at a real physical location that corresponds with the targeting area around targeting vector 404. In this FIG. the user aims the portable gaming device at one of five distant users that are visible to the user. As shown, these five distant users are members of a gaming service. Each has their own portable gaming device local to their person. In the figure, each of their portable gaming devices is worn on their waist and represented by the drawn black rectangle. One of such portable gaming devices is shown as 405 in the figure. Each of these portable gaming devices includes a position tracking sensor. In this example the position tracking sensor local to each portable gaming device is a GPS transducer integrated within the casing of each portable gaming device. Each portable gaming device is operative to detect its current position at regular intervals (by accessing the GPS transducer) and reports a representation of its current position to the UTA server following the methods described previously herein. In some embodiments each portable gaming device is operative to also report a time-stamp, a velocity, and/or a unique user identifier to the UTA server along with the representation of its current position. In some embodiments the portable gaming device also reports a facing direction for its user. The UTA server stores the received information in a tracking database that is indexed such each received position coordinate is correlated with the user and/or portable gaming device from which it was received.

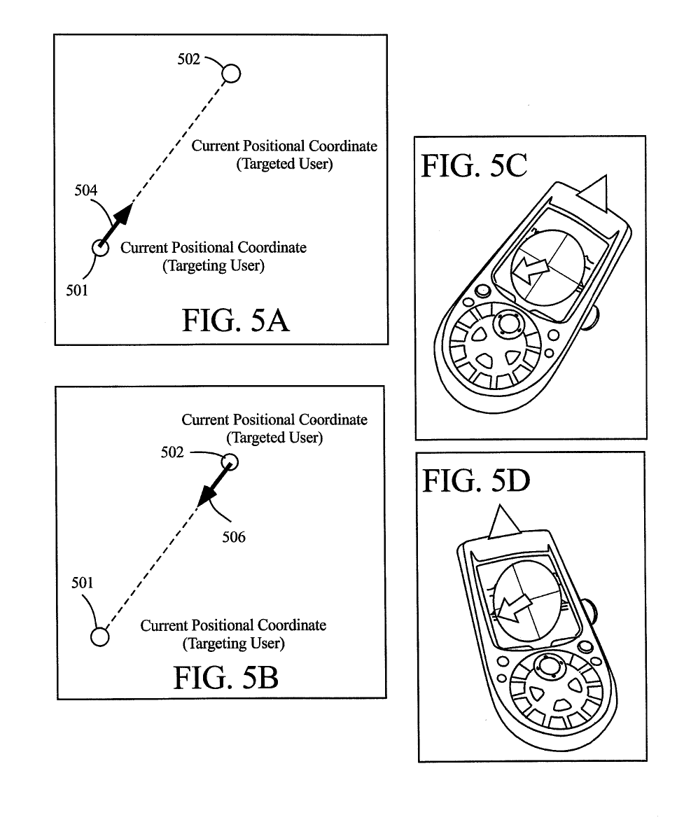

As further shown in FIG. 4, the user of the targeting portable gaming device 400 (that user not shown), aims the portable gaming device at a desired target user. Once the portable gaming device is aimed at the remote user 402 which is the forth person from the left in the figure, the targeting user presses a button (or otherwise engages the user interface on the portable gaming device). This user-interface step may further include the targeting user, by pressing an appropriate button or otherwise interacting with the user interface, specifying if he or she desires information about the targeted user, desires to initiate communication with the targeted user, or both. Upon taking such an action, the portable gaming device (400) initiates a targeting determination process by following the computational steps outlined previously herein. The first step of the targeting determination process involves portable gaming device (400) reading data from a positional sensor such as a GPS sensor at the moment in time when the targeting user pressed the button or otherwise indicated through the user interface that the portable gaming device (or a portion thereof) was properly aimed at the targeted user. This sensor reading is performed to derive a current positional coordinate for the targeting user, for example the coordinate 501 shown schematically in FIG. 5a as a shaded circle.

FIGS. 5a-5d illustrate current positional coordinates of the portable gaming device according to an embodiment of the invention. FIG. 5a schematically shows the then current location of the targeted user 502 as another shaded circle. The first step of the targeting determination process further involves the portable gaming device (400) reading data from one or more orientation sensors such as a magnetometer and/or accelerometer at the moment in time when the targeting user pressed the button or otherwise indicated through the user interface that the portable gaming device (or a portion thereof) was properly aimed at the targeted user. This sensor reading is performed to derive a targeting vector for the targeting user that ideally points in the direction from the targeting user to the targeted user (assuming successful aiming), for example the vector 504 shown schematically in FIG. 5a as an arrow.

Embodiments of the invention provide targeting duration embodiments. In some embodiments the targeting event is discrete, happening at a unique moment in time when the targeting button is first pressed (or other user interface action is first taken the indicates that the user has performed a targeting step). In other embodiments, a targeting event may occur over a period of time, for example for the duration at which the user presses and holds a targeting button (or other user interface action is taken the indicates that the user is performing a targeting step). In such “duration embodiments,” the steps of reading position sensors, orientation sensors, and computing a targeting area may be repeatedly performed at a rapid rate while the targeting duration is occurring. In addition the steps of performing a targeting determination based upon the repeatedly updated targeting area and the repeatedly updated locations of potential target users are also repeatedly performed at a rapid rate. In this way a hit may be scored upon a second user that is dependent not only upon the successful targeting of the user by a first user, but also on the duration for which the successful targeting lasts. This creates additional gaming action possibilities wherein a second user may take evasive physical action upon being targeted (i.e., move his or her location and/or orientation within the real physical world), to reduce the duration for which he or she is being targeted. This also creates additional gaming action possibilities wherein a second user may take evasive simulated action upon being targeted (i.e., engage simulated shields by interacting with a user interface of the portable gaming device).

Once the current positional coordinates (501) are determined for the targeting user and the vector 504, these values are sent from the portable gaming device (400) to the UTA server over a communication link. The UTA server then uses this information to determine a targeting area. Alternately the portable computing device may determine the targeting area and send data representative of the area to the UTA server. Either way, the targeting area is generally determined based upon additional factors such as an angular targeting range around the targeting vector, a spatial area range around the targeting vector, a targeting distance, a simulated weapon type, simulated ammunition type, simulated power level, or other simulated gaming configurations. The targeting area is oriented with respect to the real world based upon the current positional coordinates of the targeting user and the orientation of the targeting vector. Based upon the size, position, and orientation of the targeting area within the real world, the UTA server then determines which user or users are currently being targeted by the targeting user based upon which fall within the area. If a plurality of other users fall within the area, one may be selected as the targeted user based upon which user is most central within the area and/or which user is closest to the targeting user. The UTA server then determines if a hit is scored upon the targeted user(s) based upon one or more simulated factors such as the usage and/or strength of a simulated shield used by the targeted user, the type of weapon or ammunition used by the targeting user, the presence and/or configuration of intervening simulated barriers between the targeting user and the targeted user, and/or the duration of the targeting event.

If it is determined by the targeting determination process that the targeting user has successfully scored a hit upon the targeted user, the UTA server and/or the portable gaming devices of the user's in question then determine and award any gaming advantage achieved by the targeting user. This may involve the targeting user be awarded score points, health credits, ammunition credits, shield credits, treasure credits, and/or other gaming value units. This may also involve the targeted user being reduced by some amount of score points, health credits, ammunition credits, shield credits, treasure credits, and/or other gaming value units. In addition, information about the targeting user may be transmitted by the UTA server to the targeted user, and vice versa. This information is then displayed to the users on the visual and/or audio display of portable gaming device. In some embodiments communication is initiated between the users by the UTA server.

In some embodiments, moderating the communication between the targeting user and the targeted user(s) is be achieved by the UTA server routing one or more communication message(s) between the targeting user to the targeted user(s). In many embodiments the UTA server transmits such messages while masking personally identifying information thereby preserving user anonymity of one or both users.

In some embodiments the UTA server may also communicate locative information to the targeted user indicating the relative location of the targeting user with respect to the targeted user. This information may be communicated as a user locative vector that points in the direction from the targeted user to the targeting user. Such a vector will generally be the same as the targeting vector derived and sent by the targeting user but will point in the opposite direction. Thus to derive the directional vector sent to the targeted user, the UTA server generally just inverts the direction of the targeting vector that was received or derived from information sent by the targeting user. If one or more of the users are in motion, an updated user locative vector may also be computed by the UTA server based upon an updated location of the targeting user and the targeted user. The updated user locative vector will be a vector with a direction that points from the targeted user to the targeting user and can be computed from the current positional coordinates of the targeting user and the current positional coordinates of the targeted user by using common vector mathematics know to the art. This updated user locative vector is computed repeatedly based upon the changing current positional coordinates of the users and is sent repeatedly to the targeted user.

FIG. 5b shows a schematic representation of the spatial coordinates of the targeting user 501 and the targeted user 502 according to an embodiment of the invention. The UTA server, having identified the targeted user through the targeting determination process, now has access to the current positional coordinates of both users as received and stored in the tracking database. Using such coordinates, the UTA server can derive a user locative vector that points in the direction from the targeted use to the targeting user by using common vector mathematics know to the art. This user locative vector is shown schematically as arrow 506 in the figure. If one or more of the users are in motion, this vector is repeatedly computed by the UTA server based upon the updated positional coordinates for the two users. The user locative vector is sent to the portable gaming device of the targeted user by the UTA server each time it is computed.

Upon receiving the user locative vector from the UTA server, the portable gaming device of the remote user 402 may optionally display a graphical indication allowing the targeted user to visualize the direction from which he or she was targeted. This can be a graphical line or arrow that indicates the direction which the targeted user should look to see the targeting user. To draw such a graphical line or arrow, the portable gaming device of the targeted user needs to perform a number of steps. First the portable gaming device receives the user locative vector from the UTA server. Second the portable gaming device reads data from one or more orientation sensors such as a magnetometer and/or accelerometer within or upon the portable gaming device. This sensor reading is performed to derive a current orientation vector for the portable gaming device indicating the direction in which the user is currently holding the device. Using these two vectors, (i.e., a current orientation vector that indicates the direction the targeted user is holding the portable gaming device and the user locative vector that indicates the direction of the targeting user), the portable gaming device can derive the direction in which a graphical line or arrow (or other indicator) should be drawn upon the display of the portable gaming device (as it is currently being held by the targeted user) allowing that user to visualize the direction of the targeting user. Such a process is performed by using the current orientation vector as a spatial reference and then drawing the user locative vector relative to the current targeting orientation vector.

FIG. 5c illustrates an example of what would be drawn upon the display of the portable gaming device of the targeted user according to an embodiment of the invention. As shown, an arrow is drawn upon the display of the portable gaming device of the targeted user, the arrow pointing in the spatial direction of the then current location of the targeting user. In this way the targeted user can turn and look and identify the targeting user. As the targeted user turns his body and thereby changes the current orientation of his or her portable gaming device, the current orientation vector changes for the portable gaming device. Using updated current orientation vector data, the portable gaming device redraws the arrow such that it continues to point in the direction of the current location of the targeting user by accounting for the changed orientation of the targeted user's portable gaming device. An example of a redrawn arrow as it might be displayed upon the portable gaming device of the targeted user after the targeted user changed the orientation of his or her portable gaming device is shown in FIG. 5d. As is seen by comparing FIGS. 5c and 5d, the arrow changes its relative orientation as displayed upon the screen of the gaming device such that it continues to point in the absolute direction of the targeting user.

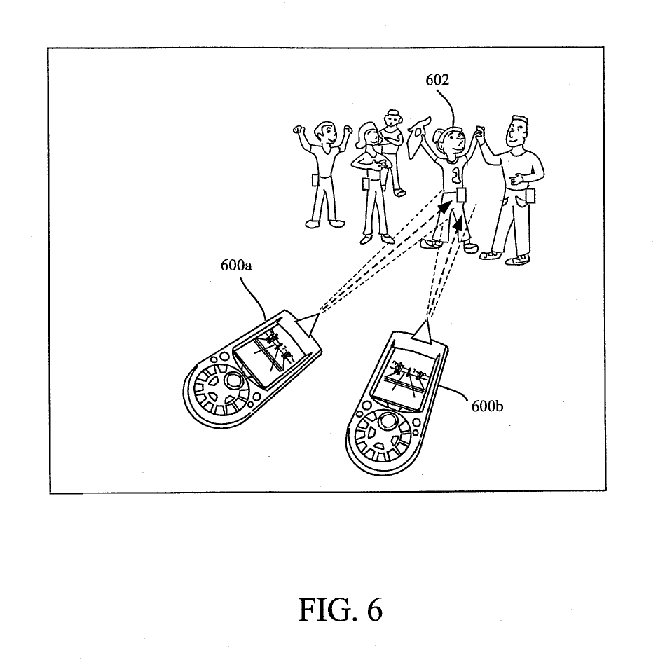

FIG. 6 illustrates a collaborative gaming process wherein two users work together to score a hit upon a third user by each targeting the third user at the same time according to an embodiment of the invention. Shown are two portable gaming devices 600a and 600b, each used by a separate user and each in wireless communication with the UTA server. Each of the portable gaming devices 600a and 600b includes a locative sensor, such as a GPS transducer, that tracks its location within the real physical world and reports that data to the UTA server. Also shown in the figure are five distant users, each with a portable computing device worn upon their belt. In this particular gaming scenario, the UTA server and gaming software is configured such that for a hit to be scored upon a particular user (for example user 602) in the figure, a plurality of other users must simultaneously target that user. This makes it substantially more challenging to score a hit upon user 602. This requirement for scoring a hit upon user 602 may be a requirement set in the gaming software for all users or may be a requirement that results from user 602 having been awarded a particular protection or using a particular simulated shield technology. In general, this requirement that a plurality of users must work together to score a hit upon a third user provides for a very unique and compelling gaming scenario.

As shown, portable gaming device 600a of a first user and portable gaming device 600b of a second user are both aimed by their users in the direction of a third user 602. The first and second user both engage a targeting button (or other user interface element) upon their respective portable gaming devices in order in indicate that a targeting event is in process. Each portable computing device then transmits data to the UTA server about its current location and current targeting vector. A targeting area is computed for each portable computing device based upon real and simulated factors such as its location and orientation, along with the type of simulated weapon, ammunition, shield, character, device, or other simulation parameter of the user of that portable gaming device. The UTA server then determines if any user falls within the targeting area of both portable gaming devices 600a and 600b. In the scenario shown in FIG. 6, user 602 has a spatial location within the real physical world that falls within the targeting area of both targeting gaming devices. The UTA server then determines, based at least in part upon this fact, that a hit has been scored upon user 602 by the collaborative efforts of the first and second users.

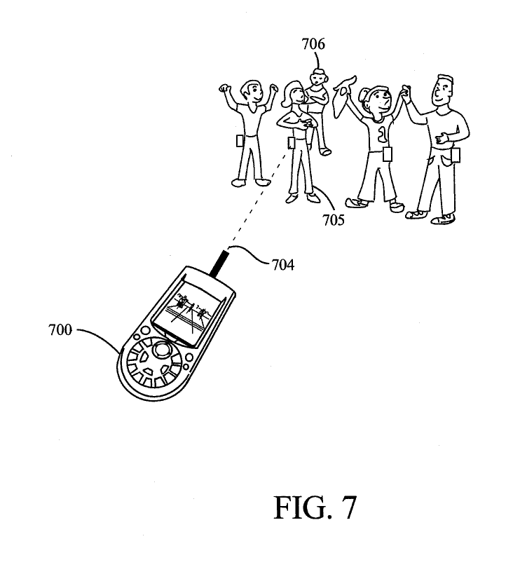

Embodiments of the invention are capable of dealing with multiple users who fall on or near a targeting vector. When the user aims the portable gaming device in a particular direction, the targeting vector that is defined will extend indefinitely and thereby may point at multiple users who are on or near the targeting vector. In many situations, the user may actually only be intending to target one of those users, most likely the user who is closest to the targeting user. To address this issue, many embodiments of the present invention are configured such that when a plurality of users fall on or near the targeting vector (as determined by the UTA server during the targeting determination process), the UTA server selects the nearest distant user to the targeting user as the target user based upon the line of sight distance between the current positional coordinates of the targeting user and the current positional coordinates of the users being aimed at. In this way the UTA sever selects the distant user who is most nearest in the foreground as viewed by the targeting user when multiple distant users fall on or near the same targeting vector. This is made clear with respect to FIG. 7.

FIG. 7 illustrates a portable gaming device (700) aimed by a targeting user in a particular direction according to an embodiment of the invention. The resulting targeting vector is the direction depicted as dotted line 704. As shown in the figure, a plurality of users fall on or near the targeting vector, including user 705 and user 706. To deal with this ambiguity, the UTA server is configured as part of the targeting determination process, to identify the user who is nearest to the targeting user as the targeted user. This may be performed through simple vector mathematics. In one embodiment this is achieved using the current positional coordinates of the targeting user and the current positional coordinates of each of the distant users who fall within a certain range of the targeting vector and computing which of the distant users is nearest to the targeting user. In the figure shown, this is user 705 for she resides nearer to the targeting user than user 706 at the time of targeting. In this way ambiguity is resolved. This allows a user to target a distant user in a crowded area and know that the nearest distant user will be targeted.

To further specify which of a plurality of distant users a targeting user is aiming at, the targeting user may use his or her user interface to specify a TARGET USER TYPE as a means of more clearly specifying which type of user the user is trying to aim at within a crowded spaced. A defined herein, TARGET USER TYPE may include any piece of information that may be included in a user's personal profile information and/or social networking information or teaming information or character type information. For example, the TARGET USER TYPE may simply specify the intended gender of the targeted user. If the targeting user specified MALE as the TARGET USER TYPE, the UTA server would then perform the targeting determination process to select the nearest user of the plurality of users who fall on or near the targeting vector who is MALE as indicated by the stored personal profile information for that user. In this way, the targeting user in the example depicted in FIG. 7 could cause the UTA server to select user 706 and not user 705 as the targeted user. Thus the added parameter of a TARGET USER TYPE is helpful in allowing a targeting user to more clearly specify which user from among a plurality of users that user is trying to target.

Similarly, a targeting user may point his or her portable gaming device at a large crowd and set range values to encompass a large number of distant users. The targeting user may also set the TARGET USER TYPE to include parameters that specify only users who are of a particular gender, team, character type, etc . . .

An additional tool that may be used for specifying which user from among a plurality of users who fall on or near a particular targeting vector is a manual roller such as the roller shown in FIG. 2. The targeting user may use the roller to scroll from near to far (or far to near) along the targeting vector, as a means of selecting users of increasing (or decreasing) distance from the targeting user along the targeting vector.

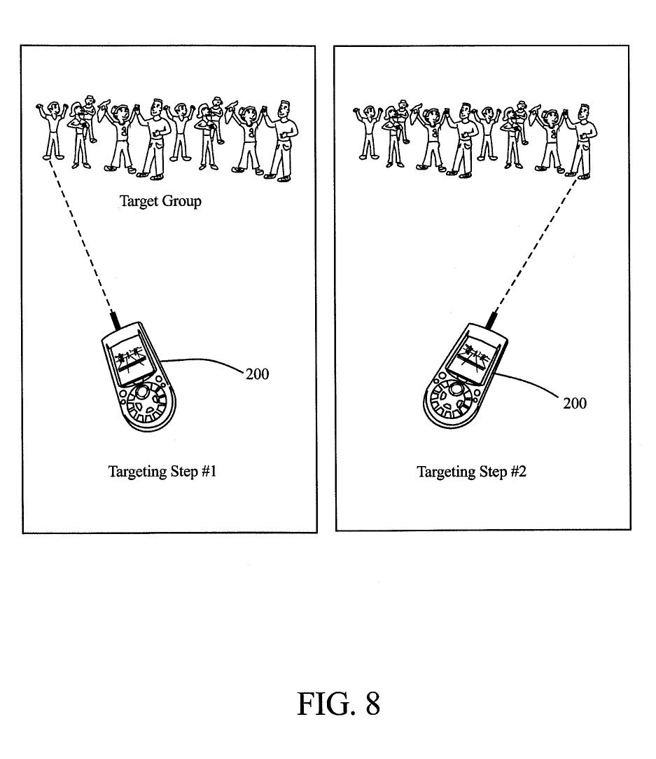

Embodiments of the invention are also capable of multi-step targeting. As described herein, a user may wish to define a group of targeted users by specifying a spatial area within the real world which those users currently reside. This may be achieved in a variety of ways as described previously herein. FIG. 8 illustrates a multi-step targeting method in which the user specifies two targeting vectors that bound an angular targeting region according to an embodiment of the invention. As shown on the left side of FIG. 8, the targeting user of portable gaming device points the portable gaming device 200 (or a portion thereof) at one edge of a bounding angular region and engages the user interface on the device to specify that first edge. Upon engaging the user interface, position and orientation data for the portable gaming device are captured from sensors. As shown on the right side of FIG. 8, the targeting user then points the portable gaming device 200 (or a portion thereof) at a second edge of a bounding angular region and engages the user interface on the device to specify that second edge. Upon engaging the user interface, position and orientation data for the portable gaming device are captured from sensors. The portable gaming device 200 then sends data to the UTA server representing the first and the second edge. This data includes a current positional coordinate and targeting vector for each edge of the bounding region; This data may also include or targeting distance, a distance range, and/or a time stamp for each edge of the bounding region. The UTA server then uses this data to determine which, if any uses currently reside within the area between the two bounding edges. As shown in FIG. 8, this area includes ten users.

Embodiments of the invention provide for distance related gaming activities. One valuable feature of the present gaming methods, system, and architecture, is that the gaming software has access to the actual physical locations of the players and can thereby compute the distance between players during the gaming action. The distance between players enables a number of inventive gaming features including but not limited to:

(a) computing the gaming advantage that results from a first user scoring a hit upon a second user with dependence upon the distance between the first user (the targeting user) and the second user (targeted user). In some embodiments the gaming advantage awarded to the first user when scoring a hit upon a second user is determined to be higher when the real physical distance between the first user and second user in the real physical world is determined to be less. This provides an incentive for a first user to try to covertly get within as close of a distance of a second user prior to scoring a hit, adding to the gaming strategy within the real physical world.

(b) providing a simulated alarm that alerts a game player when a member of an opposing team comes within certain proximity of that user. In this way a first game player that has accesses to and/or possession of such a simulated alarm within the gaming action will be alerted by the UTA server when the server determines that a member of an opposing team (or any other adverse user) has a spatial location that is within a certain proximity of the first game player. In some embodiments the proximity is set by a gaming parameter and may be, for example, a 20 foot radius around the game player. In other embodiments the proximity may be set by the game player through a configuration setting. The alarm may be provided through a visual indicator upon the screen of the portable gaming device, a tactile alert provided through an actuator on the portable gaming device, or an audible sound projected through a speaker of the portable gaming device. In this way the first game player is alerted when an adverse player approaches him or her to within some threshold distance proximity.

(c) providing a simulated shield that protects a user from part or all of the incoming targeting fire that originates from a targeting user that is more than a threshold distance away. In this way a simulated shield, such as the shields described previously in this document, may be employed around a first user such that its protective ability to block a hit or reduce the resulting effect of a hit is dependent in software, at least in part, upon the distance from which the hit was targeted upon the shield user. For example, a simulated shield may be generated in software that is operative to prevent a first user from scoring a hit upon a second user if the first user targets the second user from more than a threshold distance away (assuming the second user is using the simulated shield at the time of the targeting action). Alternately, a simulated shield may be generated in software that is operative to reduce the resulting effect of a first user scoring a hit upon a second user if the first user targets the second user from more than a threshold distance away (assuming the second user is using the simulated shield at the time of the targeting action).

(d) causing simulated damage to be inflicted upon a targeting user if that user is standing too close to a targeted user at the time the targeting is enacted. In this way if a first user targets a second user and attempts to score a hit from a distance that is less than some threshold distance away, for example five feet, the software of the present invention may compute damage and/or other negative gaming result to be inflicted upon the first user. This simulates the effect of the simulated weapon reflecting back upon the first user or otherwise casting damaging simulated effects back upon the targeting user because he or she was standing too close to his target. This provides valuable gaming strategy, forcing users not to get to close to potential targets. This also reduces the possibility that game players will actually come within physical contact of each other during game play. This effect is referred to herein as “weapon reflection” and may be set by a gaming parameter that indicates how close a targeting user may get to a targeted user before a weapon reflection effect will cause damage upon the targeting user. In some embodiments a single weapon reflection distance is used for all players and all targeting scenarios. In other embodiments the weapons reflection distance is dependent upon the weapon type used and/or ammunition type used. In other embodiments the weapon reflection distance may be dependent upon and/or altered by the targeted user using a simulated shield. In general the use of a simulated shield increases the weapon reflection distance under the gaming concept that a simulated shield causes more of the simulated weapons fire to be reflected back a the targeting user. Thus in some embodiments of the present invention a simulated shield may be employed that causes damage to be inflicted upon a targeting user if the targeting user targets a second user from a physical distance within the real world that is less than some threshold distance.

Embodiments of the invention may also provide sound effects upon getting hit. In some embodiments of the present invention the portable gaming device is configured to output a sound effect upon it being determined that targeting user has scored a hit upon that portable gaming device. This is generally performed as a result of the UTA server sending a message of the targeted portable computing device informing the portable computing device that a hit was scored upon it. A sound effect is then generated by the portable computing device, the sound effect thereby informing the user of that portable computing device that a hit was scored upon him or her. The type and or magnitude of the sound effect may be dependent upon the type of weapon used by the targeting user and/or by the distance of the targeting user. To accommodate such customization, the UTA server may also include data in the message sent about the hit indicating the weapon type, ammunition type, and or targeting distance of the targeting user. Alternately the UTA server may send a sound effect code indicating which of a plurality of sound effect types the portable computing device should output in response to the determination that a hit was scored upon it by another user. The UTA server may also communicate scoring data, health data, power data, and/or other gaming advantage data to be added or subtracted as a result of the scored hit.

Some embodiments of the invention also provide gaming action through real barriers. Another valuable feature of the present gaming methods, system, and architecture, is that targeting element, namely the targeting vector and resulting targeting area, are mathematical constructs, not real physical entities. This means they can only be blocked by simulated gaming action, not real physical action. Thus a first user may target a second user directly through a real physical wall, or through a parked car, or even from above or below through floors or ceilings. So long as the targeting vector is properly aimed and the targeting distance is within required limits, the routines of the present invention can determine if a hit was scored regardless of the intervening real-world objects. This provides for exciting and magical gaming action where users can sneak up on other users by firing through real world objects, such as walls and floors and cars and trees, etc.

Some embodiments of the invention also provide for simulated gaming barriers. While a targeting action cannot be blocked by real world physical objects present within the gaming area of the users, they can be blocked by simulated barriers so long as those barriers are represented stored within a geospatial database accessible to the UTA server and/or the portable computing devices of one or more users. A simulated barrier thus may be stored in a database as a geometric description, defining its location with respect to the real physical world, its geometry with respect to the real physical world, and it's resistance to targeting actions. A simulated barrier may for example be defined that is impermeable to all kinds of simulated weapon fire, thus preventing a first user from targeting a second user if the simulated barrier is relationally associated with a location within the real physical world that resides between the first user and the second user along the direction of the targeting vector. Alternately a simulated barrier may be defined that is impermeable to some kinds of simulated weapon but has no effect upon other kinds of simulated weapons. Alternatively a simulated barrier may be defined that is semi-permeable to simulated weapons, reducing the intensity, range, angular spread, or resulting effect of a targeting with that simulated weapon.

Some embodiments of the invention also provide for facing direction and simulated shields with directional characteristics. As described above, some embodiments of the present invention are configured such that the facing direction of users may be tracked and sent to the UTA server along with their spatial location. In some embodiments, this enables additional inventive features that provide additional gaming richness. In one such embodiment, facing direction is used in the targeting determination process to either (a) limit whether or not a hit has been scored upon a targeted user based at least in part upon the facing direction of the user being targeted, or (b) determine the effect of a hit (i.e., the type and/or magnitude of gaming advantage awarded) based at least in part upon the facing direction of the user being targeted. In one embodiment, certain users and/or certain users operating under certain modes or conditions may only bit hit by another user when the targeting vector is incident upon that user with a certain angle (or range of angles) with respect to the facing direction of the user. For example, some users may only be hit when the targeting vector aims upon them substantially from behind with respect to their facing direction. Alternately, other users may only be hit when a targeting vector aims upon them substantially from the front with respect to their facing direction. In this way gaming action can be provided with additional strategic issues such that a targeting user must hit a targeted user either substantially from the front (with respect to the targeted users facing direction) or substantially from behind (with respect to the targeted user's facing direction. In some embodiments the gaming scenario may be configured such that a first user achieves a larger gaming advantage when targeting a second user from behind with respect to their facing direction.

Some embodiments of the invention provide for time dependent shields and barriers. In some embodiments of the present invention that support targeting duration features as described previously, simulated shields and/or simulated barriers may be defined with a minimum time threshold such that a targeting user can penetrate the shield or barrier if the targeting action is maintained upon the shield or barrier for more than the minimum time threshold amount of time. This creates additional gaming strategy elements in which a targeting user must not simply target a distant second user but maintain the targeting action upon the second user for more than a minimum time threshold amount of time in order to score a hit upon that second user.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A system for implementing a multiplayer mobile gaming experience, comprising:
a first portable computing device operated by a first user, the first portable computing device including a first geospatial location sensor, a first geospatial orientations sensor, a first user aiming portion, and a first wireless communication link to a user tracking application server;
a plurality of second portable computing devices, each operated by a separate second user, each second portable computing device including a second geospatial location sensor, a second geospatial orientation sensor, a second user aiming portion, and a second wireless communication link to the user tracking application server;
first communication routines for transmitting a representation of substantially current data from the first geospatial location sensor and the first orientation sensor from the first portable computing device to the user tracking application server;
second communication routines for repeatedly transmitting a representation of substantially current data from the second geospatial location sensor of each of the plurality of second portable computing devices to the user tracking application server;
gaming software routines running upon or in conjunction with the user tracking application server, the gaming software routines:
receiving an indication that the first user of the first portable computing device has fired a simulated weapon as a result of engaging an appropriate user interface element of the first portable computing device;
determining, for a time period associated with the simulated weapon fire, if the aiming portion of the first portable computing device was aimed substantially at the location of a particular second portable computing device, the determining being performed at least in part based upon the data from the first geospatial location sensor and first geospatial orientation sensor of the first portable computing device, and the second geospatial location sensor of the particular second portable computing device; and
assessing whether a user of the first portable computing device scored a simulated weapon hit upon a user of a particular second portable computing device based at least in part upon the receiving and the determining.

2. The system of claim 1, wherein each of the first geospatial location sensor and the second geospatial locations sensor include a global Positioning Sensor (“GPS”) transducer.

3. The system of claim 1, wherein each of the first geospatial orientation sensor and the second geospatial orientation sensor include a magnetometer.

4. The system of claim 1, wherein the user tracking application server maintains a database of substantially current location information for the first portable computing device and the plurality of second portable computing devices.

5. The system of claim 1, wherein the assessing is based at least in part upon usage of simulated shields associated with the particular second portable computing device.

6. The system of claim 5, wherein the assessing is based at least in part upon at least one of a simulated strength level and a power level of the simulated shields.

7. The system of claim 1, wherein the assessing is based at least in part upon a computed geospatial distance between the geospatial location of the first portable computing device and the particular second portable computing device.

8. The system of claim 1, wherein the assessing is based at least in part upon a determination as to whether any simulated obstacles or barriers are present within the straight line path between the geospatial location of the first portable computing device and the particular second portable computing device.

9. The system of claim 1, wherein the determining is based at least in part upon execution of mathematical operations to determine whether a vector starting from a spatial location of the first portable computing device and extending in a direction of the user aiming portion of the first portable computing device comes within certain proximity of a spatial location of the particular second portable computing device.

10. The system of claim 1, wherein the determining is based at least in part upon mathematical operations that determine whether the spatial location of the particular second portable computing device falls within an area or volume around a vector starting from a spatial location of the first portable computing device and extending in a direction of the user aiming portion of the first portable computing device.

11. The system of claim 10, wherein the area or volume is an approximately wedge shaped area of a cone shaped volume around the vector.

12. The system of claim 1, wherein simulated shield levels associated with the particular second portable computing device are reduced in response to an assessment that the user of the first portable computing device has scored a simulate weapon hit upon the user of the particular second portable computing device.

13. The system of claim 1, wherein simulated health levels associated with the particular second portable computing device are reduced in response to an assessment that the user of the first portable computing device has scored a simulate weapon hit upon the user of the particular second portable computing device.

14. The system of claim 1, wherein a sound is output by the particular second portable computing device in response to an assessment that the first user of the first portable computing device has scored a simulated weapon hit upon the user of the particular second portable computing device.

15. The system of claim 1, wherein a sound is output by the first portable computing device in response to an assessment that the first user of the first portable computing device has scored a simulated weapon hit upon the user of the particular second portable computing device.

16. The system of claim 1, wherein the gaming software is further operative to update a score associated with at least one of the first portable computing device and the particular second portable computing device based at least in part upon an assessment that the first user of the first portable computing device has scored a simulated weapon hit upon the user of the particular second portable computing device.

17. The system of claim 1, wherein the gaming software is further operative to compute a damage level associated with the particular second portable computing device in response to an assessment that the first user of the first portable computing device has scored a simulated weapon hit upon the user of the particular second portable computing device, the damage level being determined based at least in part upon a simulated strength or power level of a simulated shield associated with the particular second portable computing device.

18. A method for implementing a multiplayer mobile gaming experience, comprising:
receiving, over a wireless communication link, substantially current first geospatial location and first orientation data for a first portable computing device;
receiving, over the wireless communication link, substantially current second geospatial location data for each of a plurality of second portable computing devices;
receiving, over the wireless communication link, an indication that a first user of the first portable computing device has fired a simulated weapon by engaging an appropriate user interface element of the first portable computing device;
determining, for a time period associated with the simulated weapon fire, if an aiming portion of the first portable computing device was aimed substantially at a location of a particular second portable computing device, the determining being performed at least in part based upon the data from the substantially current first geospatial location and first orientation data for the first portable computing device, and the substantially current second geospatial location data for the particular second portable computing device; and
assessing whether the first user of the first portable computing device scored a simulated weapon hit upon a second user of a particular second portable computing device.

19. The method of claim 18, wherein the method further includes maintaining a database of substantially current location information for the first portable computing device and the plurality of second portable computing devices.

20. The method of claim 18, wherein the assessing is based at least in part upon a computed geospatial distance between the substantially current first geospatial location of the first portable computing device and the substantially current second geospatial location of the particular second portable computing device.

21. The method of claim 18, wherein the assessing is based at least in part upon a determination as to whether any simulated obstacles or barriers are present within a straight line path between the substantially current first geospatial location of the first portable computing device and the substantially current second geospatial location particular second portable computing device.

22. The method of claim 18, wherein the determining is based at least in part upon execution of mathematical operations that determine whether a vector starting from a first spatial location of the first portable computing device and extending in a direction of the user aiming portion of the first portable computing device comes within certain proximity of a second spatial location of the particular second portable computing device.

23. The method of claim 18, wherein the determining is based at least in part upon execution of mathematical operations that determine whether a second spatial location of the particular second portable computing device falls within an area or volume around a vector starting from a first spatial location of the first portable computing device and extending in a direction of a user aiming portion of the first portable computing device.

24. The method of claim 23, wherein the area or volume is an approximately wedge shaped area of a cone shaped volume around the vector.

25. The method of claim 18, wherein simulated shield levels associated with the particular second portable computing device are reduced in response to an assessment that the first user of the first portable computing device has scored a simulated weapon hit upon the second user of the particular second portable computing device.

26. The method of claim 18, wherein simulated health levels associated with the particular second portable computing device are reduced in response to an assessment that the first user of the first portable computing device has scored a simulated weapon hit upon the second user of the particular second portable computing device.

27. The method of claim 18, wherein a sound is output by the particular second portable computing device in response to an assessment that the first user of the first portable computing device has scored a simulated weapon hit upon the second user of the particular second portable computing device.

28. The method of claim 18, wherein a sound is output by the first portable computing device in response to an assessment that the first user of the first portable computing device has scored a simulated weapon hit upon the second user of the particular second portable computing device.

29. The method of claim 18, further operative to update a score associated with at least one of the first portable computing device and the particular second portable computing device based at least in part upon an assessment that the first user of the first portable computing device has scored a simulated weapon hit upon the second user of the particular second portable computing device.

30. The method of claim 18, further operative to compute a damage level associated with the particular second portable computing device in response to an assessment that the first user of the first portable computing device has scored a simulated weapon hit upon the second user of the particular second portable computing device, the damage level being determined based at least in part upon a simulated strength or power level of a simulated shield associated with the particular second portable computing device.

31. A method of providing a gaming experience to a group of portable gaming devices within a predefined spatial area, comprising:
receiving and storing positional data and orientational data from each of the portable gaming devices in a tracking database;
reading position and orientation sensors local for a first portable gaming device to determine a current location and a current targeting vector for the first portable gaming device;
determining a targeting area within a real physical world based on the current location and the current targeting vector;
determining whether the first portable gaming device scores a hit on a second portable gaming device within the targeting area; and
updating a gaming score value based at least in part upon an affirmative determination that the first portable gaming device scores a hit on a second portable gaming device.

32. The method of claim 31, further comprising emitting a sound in response to the hit.

33. The method of claim 31, wherein the updating a gaming score value is performed dependent at least in part upon a presence or level of a simulated shield associated with the second portable gaming device.

34. The method of claim 31, wherein the updating a gaming score value is performed dependent at least in part upon a plurality of first portable gaming devices each scoring a hit upon the second portable computing device at approximately the same time.
